(19) United States
(12) Patent Application Publication
(10) Pub. No.: US 2026/0166768 A1
(43) Pub. Date: Jun. 18, 2026

(54) REMOVAL METHOD AND REMOVAL DEVICE FOR REMOVING GLASS PANES OF AN INSULATING GLAZING UNIT FROM THE SPACER FRAME, METHOD AND DEVICE FOR TAKING AN INSULATING GLAZING UNIT APART AND PROCESSING METHOD AND PROCESSING DEVICE FOR PROCESSING INSULATING GLAZING UNITS

(71) Applicant: HEGLA GmbH & Co. KG, Beverungen (DE)

(72) Inventors: Markus Schoisswohl, Beverungen (DE); Marcel Hötger, Beverungen (DE); Friedhelm Daut, Beverungen (DE); Marcel Plappert, Beverungen (DE); Heinrich Ostendarp, Beverungen (DE); Stefan Asche, Beverungen (DE)

(21) Appl. No.: 18/996,136

(22) PCT Filed: Sep. 19, 2023
(86) PCT No.: PCT/EP2023/075784

§ 371 Date: Jan. 21, 2026

(30) Foreign Application Priority Data
Sep. 19, 2022 (DE) 10 2022 209 846.3

(51) Int. Cl. B26D 1/18; B26D 7/08; B26D 7/27; E06B 3/663

(52) U.S. Cl. CPC B26D 1/18; B26D 7/088; B26D 7/27; E06B 3/66352

(57) ABSTRACT

A separation method and a separation device for the non-destructive separation of glass panes of an insulating glazing from the spacer frame of the insulating glazing unit, as well as a method and a device for disassembling an insulating glazing and a reprocessing method and a reprocessing device for reprocessing insulating glazing units.

### CROSS REFERENCE TO RELATED APPLICATIONS

This application is a 35 U.S.C § 371 national phase application of International Application No. PCT/EP2023/075784, filed Sep. 19, 2023, which claims the benefit of priority under 35 U.S.C. § 119 to German Patent Application No.: 10 2022 209 846.3, filed Sep. 19, 2022, the contents of which are incorporated herein by reference in their entirety.

### FIELD

The present invention relates to a separation method and a separation device for the non-destructive separation of glass panes of an insulating glazing from the spacer frame of the insulating glazing, as well as a method and a device for disassembling an insulating glazing and a reprocessing method and a reprocessing device for reprocessing insulating glazing units.

### BACKGROUND

The statements in this section provide background information related to the present disclosure, definitions for terms used in the present disclosure, and other basic information regarding the present invention in order to provide a better understanding of the overall disclosure. In doing so, these statements may not constitute prior art.

Insulating glazing is also known as multi-pane insulating glass. Conventional insulating glazing comprises at least two glass panes arranged parallel and at a distance from each other, between which a gas-filled, gas-tight and moisture-tight pane interspace of a defined width is provided. In order to permanently guarantee this predefined pane interspace, a circumferential spacer frame is provided between the two glass panes of glass, which connects the two glass panes to each other in the area of their pane outer edges. The spacer frame consists of a thin-walled spacer tube with an essentially flat rectangular cross-section. Such spacer tubes are also usually made of metal, in particular stainless steel or aluminum. Plastic versions are also available.

On the outer side surfaces of the spacer tubes there is also a primary seal, preferably made of butyl, which bonds the spacer tubes to the glass panes and seals the pane interspace from the ambiance. Furthermore, there is an edge seal (secondary seal) outside around the spacer frame, which increases the rigidity of the insulating glazing and additionally ensures tightness.

TPS spacers (Thermo Plastic Spacer) are also known. These consist of a rubber compound that is already applied to the glass panes during the production of insulating glazing units.

The pane interspace is also filled with air or another gas, e.g. argon or xenon.

Recently, more and more efforts have been made to recycle insulating glazing units, particularly in order to reduce CO₂ emissions.

Glass is fundamentally predestined for a closed-loop recycling economy. This is because the use of glass fragments not only conserves natural raw material resources, but also reduces the melting energy required and therefore also the CO₂ emissions that occur. For example, in flat glass production, the use of 10% recycled material can achieve energy savings of around 3% and a reduction in CO₂ emissions of around 3.6 percent.

One may also remove the glass panes from the insulating glazing without damaging them and to reuse the removed glass panes for the manufacture of a new insulating glazing (upcycling).

AT 364 513 discloses a method and a device for disassembling insulating glass, wherein a base plate which can be placed on a glass pane carries at least one handle on one side and a knife blade which is parallel to the base plate and can be adjusted perpendicular to the base plate on the other side. The knife blade is essentially triangular in shape and is clamped in a knife carrier which comprises a shaft which can be displaced and clamped in a sleeve fixed on the base plate.

The base plate of the AT 364 513 device is placed against one of the panes of the insulating glass so that the handles are pointing upwards and the knife blade is below the base plate. The knife blade is now adjusted perpendicular to the base plate and thus also to the glass pane until it can penetrate into the edge gap between the two glass panes while resting against one pane and until it can remove the sealing compound from the glass pane when the base plate is moved parallel to the edge of the pane. Once the sealant compound has been released from one pane, the knife blade is adjusted by the width of the edge gap between the panes so that it now rests against the other pane and separates the pane and sealant compound when the base plate is moved. The metal profiles are then removed from the glass panes.

EP 1 031 542 A2 discloses a device and a method for disassembling insulating glass, wherein the edge area of the insulating glass comprising the spacer is cut off by means of a jet of water directed perpendicular to the glass panes.

In a similar way, the edge area is cut off using cutting wheels according to U.S. Pat. No. 8,621,738 B2.

According to WO 2020/018377 A1, the two glass panes of an insulating glass are separated from the spacer using a heated knife. The two glass panes are broken for subsequent recycling.

In a method developed by PushCorp, the spacer is cut through using a rapidly rotating separating saw blade (https://www.youtube.com/watch?v=72Oxh2OvNwk). The circular saw blade is moved relative to the insulating glass. The spacer residues still adhering to the glass panes are then milled off and the primary and secondary seals are removed using grinding wheels.

One objective of the present disclosure is to provide a separation method and a separation device for non-destructive separation of the glass panes from the spacer frame of an insulating glazing, which ensures the gentlest possible separation and good quality of the separated glass panes.

In particular, it should also be ensured that the spacer frame is not damaged so that no drying agent leaks out.

Another objective of the present disclosure is to provide a method for disassembling insulating glazing units.

A further objective of the present disclosure is to provide a reprocessing device for reprocessing insulating glazing units with such a separating device and a reprocessing method.

### SUMMARY

The above-mentioned objectives are solved by a separation method for separating a glass pane of an insulating glazing from a, preferably rigid, spacer frame connected to the glass pane by a primary seal, wherein a secondary seal, which is also connected to the glass pane, is arranged outside around the spacer frame, whereby the secondary seal and the primary seal are cut through with a knife, wherein a rotary knife, preferably a circular knife, rotating about a knife rotation axis is used to separate the secondary seal and the primary seal, wherein the rotary knife is lubricated during the separation process with a, preferably liquid, lubricant, preferably with a lubricating emulsion, in particular with a water-based or oil-based lubricating emulsion, or with a lubricating oil or with water.

The above-mentioned objectives are further solved by a method for disassembling insulating glazing with at least two glass panes arranged parallel to and spaced apart from one another and with a spacer frame arranged between the glass panes in a pane boundary area, wherein a pane interspace is delimited by the glass panes and the spacer frame, wherein the spacer frame is bonded to the two glass panes via a primary seal respectively and wherein the insulating glazing comprises a secondary seal arranged outside around the spacer frame, wherein for disassembling the spacer frame and the secondary seal are separated from the glass panes, wherein the separation of the secondary seal and also of the spacer frame from the glass panes is carried out according to the separation method as previously described above and further defined herein.

According to another aspect of the present disclosure, the objectives are also addressed by a reprocessing method for the, in particular automated, reprocessing of insulating glazing with at least two glass panes arranged parallel to and spaced apart from one another and with a spacer frame arranged between the glass panes in a pane boundary area, wherein a pane interspace is delimited by the glass panes and the spacer frame, wherein the spacer frame is bonded to the two glass panes via a primary seal respectively and wherein the insulating glazing comprises a secondary seal arranged outside around the spacer frame, with the following method steps:
a) Preferably measuring the insulating glazing to be disassembled,
b) Preferably degassing the pane interspace,
c) Disassembling the insulating glazing according to method discussed above and further defined herein, and
d) Preferably removing of sealing residues of the primary and secondary seal adhering to the glass panes.

According to yet another aspect of the present disclosure a separation device is provided. The separation device, is preferably for carrying out the separation method provided herein for separating at least one glass pane of an insulating glazing from a, preferably rigid, spacer frame connected to the glass pane by a primary seal, wherein a secondary seal, which is also connected to the glass pane, is arranged outside around the spacer frame, wherein the separation device comprises at least one knife for separating, wherein the knife is a rotary knife, preferably a circular knife, rotatable about a knife rotation axis, wherein the separation device preferably comprises a knife drive motor (30), to which the rotary knife is connected so that it can be driven to rotate about the knife rotation axis, the separation device comprises at least one separation head, which comprises at least one rotary knife, preferably at least two rotary knifes, which is mounted rotatably about the knife rotation axis, wherein the at least one separation head comprises a lubricating device for lubricating the at least one rotary knife with a, preferably liquid, lubricant, preferably a lubricating emulsion, in particular a water-based or oil-based lubricating emulsion, or a lubricating oil or water.

The above-mentioned objectives are further addressed herein via a reprocessing device for the, in particular automated, reprocessing of insulating glazing with at least two glass panes arranged parallel to and spaced apart from one another and with a spacer frame arranged between the glass panes in a pane boundary area, wherein a pane interspace is delimited by the glass panes and the spacer frame, wherein the spacer frame is bonded to the two glass panes via a primary seal and wherein the insulating glazing has a secondary seal arranged outside around the spacer frame:
a) Preferably an inspection device for measuring the insulating glazing to be disassembled,
b) Preferably a degassing device for degassing the pane interspace,
c) A separation device as described above and further defined herein for disassembling the insulating glazing,
d) Preferably a sealing residue removal device for removing sealing residues of the primary and secondary seal adhering to the glass panes.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

In order that the description may be well understood, the present disclosure is explained in more detail below with reference to the accompanying drawings, in which:

FIG. 1: shows a highly simplified and schematically a section through a double insulating glazing;

FIG. 2: shows a side view of the separating device according to the first embodiment of the present disclosure with an insulating glazing in a receiving area;

FIG. 3: shows a side view of the separating device according to a first embodiment of the present disclosure with the insulating glazing in an advanced position;

FIG. 4: shows a side view of the separating device according to the first embodiment of the present disclosure with the insulating glazing in the advanced position, an upper horizontal separation head engaged;

FIG. 5: shows a side view of the separating device according to the first embodiment of the present disclosure with the insulating glazing in a further advanced position, upper horizontal separation head engaged;

FIG. 6: shows a side view of the separating device according to the first embodiment of the present disclosure with the insulating glazing in an even more advanced position, upper separation head engaged;

FIG. 7: shows a side view of the separating device according to the first embodiment of the present disclosure during the horizontal separation process;

FIG. 8: shows a side view of the separating device according to the first embodiment of the present disclosure with the insulating glazing in a removal area and, rotated by 90° in the receiving area;

FIG. 9: shows a 90° rotated side view of the separating device according to the present disclosure;

FIG. 10: shows an enlarged side view of the upper horizontal separation head;

FIG. 11: shows another enlarged side view, rotated by 90°, of the upper horizontal separation head;

FIG. 12: shows an enlarged side view of the lower horizontal separation head;

FIG. 13: shows another enlarged side view of the lower horizontal separation head, rotated by 90°;

FIG. 14: shows a highly simplified and schematic view of individual components of the two horizontal separation heads;

FIG. 15: shows another simplified and schematic view of individual components of the two horizontal separation heads;

FIG. 16: shows a partially sectioned top view of the lower horizontal separation head;

FIG. 17: shows another side view of the lower horizontal separation head;

FIG. 18: shows a longitudinal section through a rotary knife;

FIG. 19: shows a schematic representation of a reprocessing device;

FIG. 20: shows a side view of an inspection device and a degassing device of the reprocessing device;

FIG. 21: shows a side view of the separation device of the reprocessing device at different stages of the process;

FIG. 22: shows another side view of the separation device of the reprocessing device at different stages of the process;

FIG. 23: shows another side view of the separation device of the reprocessing device;

FIG. 24: shows a side view of a sealing residue removal device of the reprocessing device;

FIG. 25: shows a further side view of the separation device according to a further embodiment of the present disclosure;

FIG. 26: shows a highly simplified and schematic representation of an inclination of a knife rotation axis about a first knife axis inclination axis;

FIG. 27: shows a highly simplified and schematic representation of an inclination of the knife rotation axis around a second knife axis inclination axis;

FIG. 28: shows a perspective view of components of the lower horizontal separation head of the separation device according to a further embodiment of the present disclosure;

FIG. 29: shows a highly simplified and schematic side view of the rotary knife under bending load;

FIG. 30: shows a highly simplified and schematic top view of the rotary knife with an insulating glazing and an neutral circumferential line;

FIG. 31: shows a simplified and schematic top view of a separation device according to a further embodiment of the present disclosure with an insulating glazing during the separation process;

FIG. 32: shows a simplified and schematic top view of a separation device according to a further embodiment of the present disclosure with an insulating glazing prior to the separation process of the upper glass pane;

FIG. 33: shows a simplified and schematic top view of the separation device according to the further embodiment of the present disclosure with an insulating glazing at the start of the separation process of the upper glass pane;

FIG. 34: shows a simplified and schematic top view of the separation device according to the further embodiment of the present disclosure with the insulating glazing during the separation process of the upper glass pane;

FIG. 35: shows a simplified and schematic top view of the separation device according to the further embodiment of the present disclosure with the insulating glazing at the end of the separation process of the upper glass pane;

FIG. 36: shows a simplified and schematic top view of the separation device according to the further embodiment of the present disclosure with the insulating glazing at the start of the separation process of the lower glass pane;

FIG. 37: shows a simplified and schematic top view of the separation device according to the further embodiment of the present disclosure with the insulating glazing during the separation process of the lower glass pane;

FIG. 38: shows a simplified and schematic top view of the separation device according to the further embodiment of the present disclosure with the insulating glazing at the end of the separation process of the lower glass pane;

FIG. 39: shows a simplified and schematic top view of the separation device according to the further embodiment of the present disclosure when rotating the insulating glazing;

FIG. 40: shows a simplified and schematic top view of the separation device according to the further embodiment of the present disclosure with the rotated insulating glazing before the separation process of the upper glass pane;

FIG. 41: shows a simplified and schematic top view of the separation device according to the further embodiment of the present disclosure with the rotated insulating glazing at the end of the separation process of the lower glass pane;

FIG. 42: shows a simplified and schematic top view of a separation device according to the invention according to a further embodiment of the present disclosure with two insulating glazing units during the separation process of the upper glass pane;

FIG. 43: shows a highly simplified and schematic top view of a separation device according to the invention according to a further embodiment of the present disclosure with an insulating glazing prior to the separation process of the front glass pane along the lower insulating glazing edge;

FIG. 44: shows a simplified and schematic top view of the separation device according to the further embodiment of the present disclosure with an insulating glazing at the start of the separation process of the front glass pane along the lower insulating glazing edge;

FIG. 45: shows a simplified and schematic top view of the separation device according to the further embodiment of the present disclosure with the insulating glazing shortly before the end of the separation process of the front glass pane along the lower insulating glazing edge;

FIG. 46: shows a simplified and schematic top view of the separation device according to the further embodiment of the present disclosure with the insulating glazing shortly before the end of the separation process of the front glass pane along the lower insulating glazing edge;

FIG. 47: shows a simplified and schematic top view of the separation device according to the further embodiment of the present disclosure with the insulating glazing at the end of the separation process of the front glass pane along the lower insulating glazing edge;

FIG. 48: shows a simplified and schematic top view of the separation device according to the further embodiment of the present disclosure with the insulating glazing at the beginning of the separation process of the front glass pane along a vertical insulating glazing edge;

FIG. 49: shows a simplified and schematic top view of the separation device according to the further embodiment of the present disclosure with the insulating glazing at the end of the separation process of the front glass pane;

FIG. 50: shows a schematic representation of the threading process of a rotary knife due to its flexibility;

FIG. 51: shows a schematic representation of the threading process of the rotary knife due to a floating bearing; and

FIGS. 52a-c: shows different cutting edge shapes of the rotary knife.

The drawings are provided herewith for purely illustrative purposes and are not intended to limit the scope of the present disclosure.

### DETAILED DESCRIPTION

The following description is merely exemplary in nature and is in no way intended to limit the present disclosure or its application or uses. It should be understood that throughout the description, corresponding reference numerals indicate like or corresponding parts and features.

Within this specification, embodiments have been described in a way which enables a clear and concise specification to be written, but it is intended and will be appreciated that embodiments may be variously combined or separated without parting from the invention. For example, it will be appreciated that all preferred features described herein are applicable to all aspects of the invention described herein.

In general, the present disclosure provides a separation method and a separation device for the non-destructive separation of glass panes of an insulating glazing from the spacer frame of the insulating glazing, as well as a method and a device for disassembling an insulating glazing and a reprocessing method and a reprocessing device for reprocessing insulating glazing units.

Referring to the Figures, the preferably rectangular insulating glazing or multi-pane insulating glass 1 to be disassembled comprises at least two spaced glass panes 2, a spacer frame 3 arranged between them, a primary seal 4 and an edge seal or secondary seal 5.

The spacer frame 3, the primary seal 4 and the secondary seal 5 form the edge bond of the insulating glazing 1.

The two glass panes 2 each comprise an outer pane surface 2a and an inner pane surface 2b as well as preferably four outer pane edges 2c adjoining each other in pairs. In addition, the glass panes 2 are either individual glass panes 2, each of which has only a single glass plate 6 (FIG. 1), or laminated glass panes consisting of several glass plates joined together (not shown). Laminated glass panes are known to be a laminate of at least two individual glass plates, which are respectively bonded together by means of an adhesive intermediate layer of plastic, in particular by a highly tear-resistant, viscoplastic, thermoplastic film.

In the case of a double insulating glazing 1 (FIG. 1), the two outer pane surfaces 2a also each form a first and a second outer insulating glazing surface 1a;1b of the insulating glazing 1. In the case of multiple insulating glazing 1 with more than two glass panes 2, the two outer pane surfaces 2a of the two outer glass panes 2 respectively form the outer insulating glazing surfaces 1a;1b of the insulating glazing 1. And the inner glass pane(s) 2 then only comprise two inner pane surfaces 2b. The rectangular insulating glazing 1 also comprises four insulating glazing edges 1c adjoining each other in pairs.

Depending on the area of application, the glass panes can be made of mineral silicate glass or plastic. They are preferably made of mineral glass.

There is a pane interspace or pane inner space or gap 7 between the two glass panes 2. The circumferential spacer frame 3 is provided between the two glass panes 2 in order to permanently guarantee this predefined pane inner space 7. The spacer frame 3 connects the two glass panes 2 to each other in the pane edge area or in the area of their pane outer edges 2c.

The spacer frame 3 is preferably rigid and consists of a circumferential, bent spacer tube 8 or several spacer tubes 8, which are connected to each other in pairs by means of a corner connector.

However, the spacer frame 3 can also be a flexible spacer frame 3 known per se. As is known per se, the flexible spacer frame consists of a bent flexible strand material made of plastic, preferably a plastic foam, preferably silicone foam, and comprises a diffusion barrier.

Each spacer tube 8 comprises a tube wall 9. The tube wall 9 surrounds a spacer tube interior 8a, which is preferably filled with a drying agent 50.

The tube wall 9 comprises a base wall 10, preferably with a flat surface, a top wall 11 opposite to it and preferably parallel to it, and two side walls 12, preferably with a flat surface. A transition wall 13 is also expediently provided between one side wall 12 and the base wall 10 in each case. The side walls 12 and the top wall 11 preferably merge directly into each other. The two transition walls 13 are preferably designed as a type of chamfer, i.e. the corner area between each side wall 12 and the base wall 10 is flattened by the transition walls 13.

The top wall 11 is also preferably perforated in a manner known per se, so that gas exchange with the drying agent 50 in the spacer tube interior 8a is possible.

The primary seal 4, which bonds the spacer tube 8 to the glass panes 2 and seals the pane interspace 7 from the surroundings, is also present on the side wall outer surfaces of the side walls 12. The primary seal 4 is preferably made of polyisobutylene or butyl rubber.

The secondary seal 5 is arranged outside around the base wall 10 of the spacer tube 8. The secondary seal 5 is preferably made of paste-like polyurethane, silicone or special polysulphides.

The pane interspace 7 is sealed in a gas-and moisture-tight manner from the surroundings by means of the two seals 4;5 and is also filled with gas, preferably air or another gas, e.g. sulfur hexafluoride (S₆), argon or xenon.

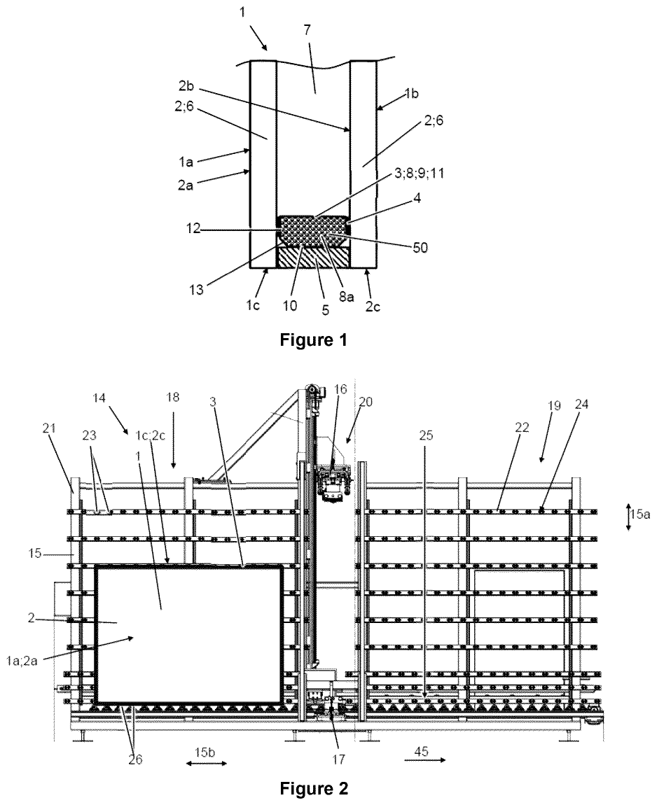

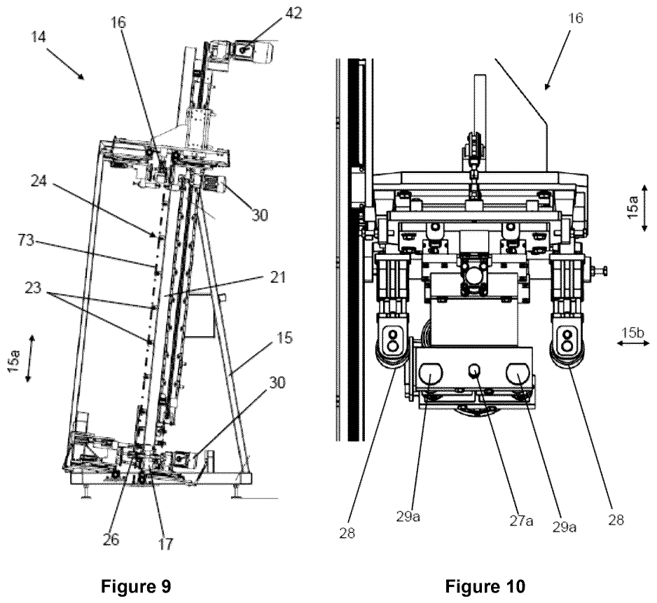

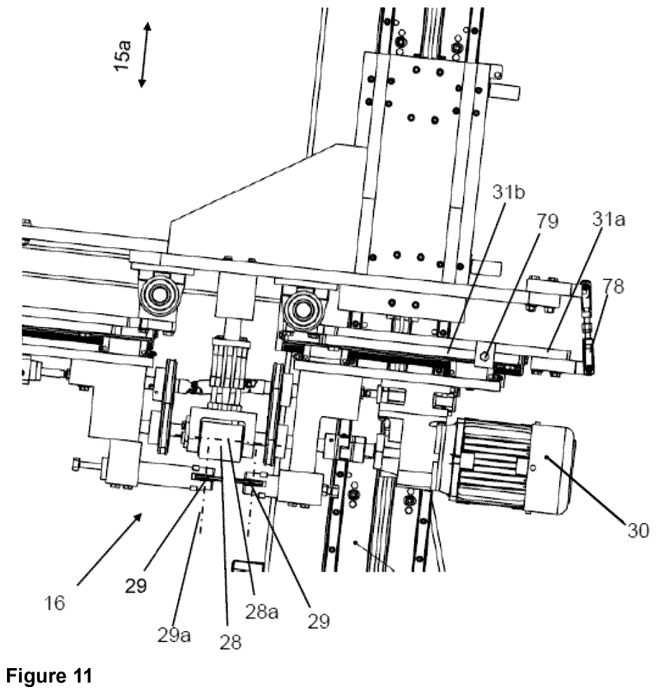

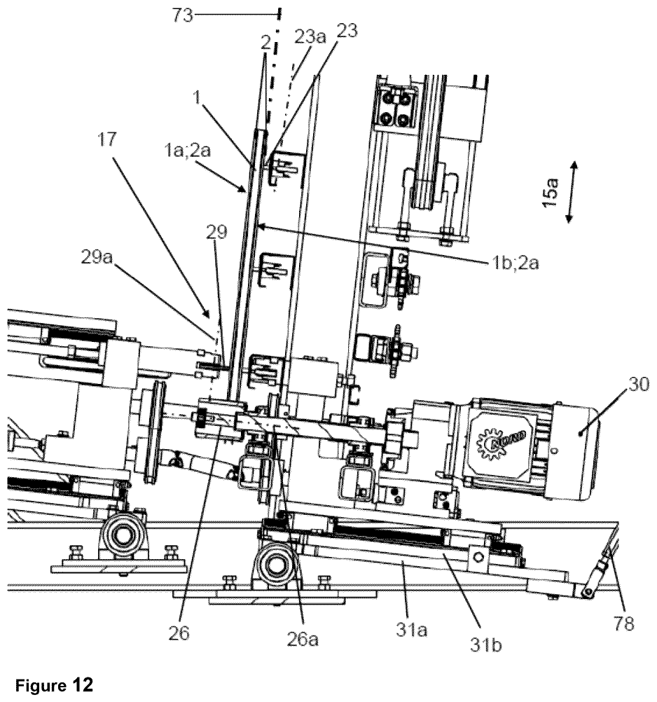

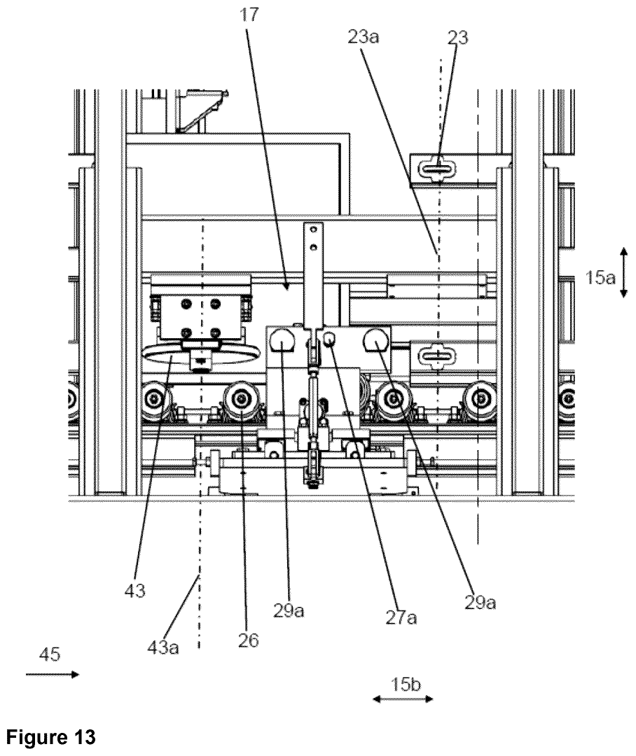

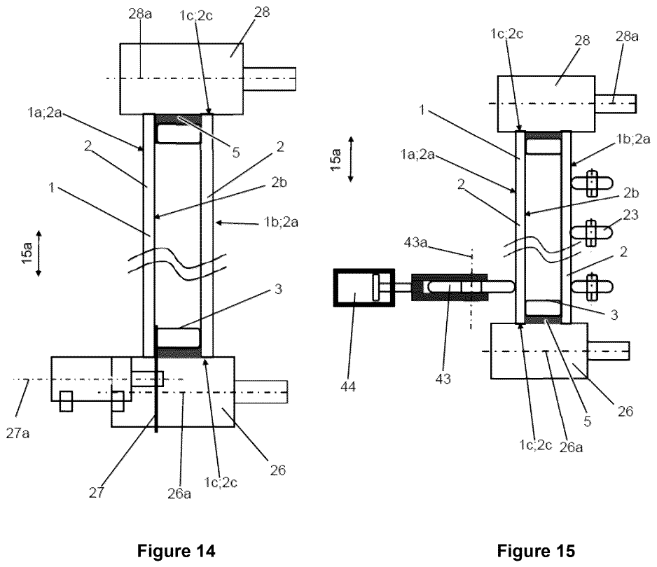

According to a first embodiment of the invention (FIGS. 2-9), the separation device 14 according to the invention comprises a base frame 15 and two horizontal separation heads 16; 17, namely an upper horizontal separation head 16 and a lower horizontal separation head 17.

The separation device 14 comprises a height direction 15a and a transverse direction 15b perpendicular to it. The transverse direction 15b is in particular horizontal. The height direction 15a is vertical or preferably inclined slightly to the vertical about an axis parallel to the transverse direction 15b. Preferably, an abutment plane inclination angle α is 3° to 10°, preferably 4° to 8°. In the context of the invention, “vertical” separating is therefore understood in the following to mean separating along an insulating glazing edge 1c which extends parallel to the height direction 15a, i.e. is vertical or slightly inclined to the vertical.

The base frame preferably comprises two frame areas 18;19, preferably a receiving area 18 and a removal area 19, spaced apart from each other in the transverse direction 15b. An intermediate frame space or cutting area 20 is therefore provided between the two frame areas 18; 19.

The two horizontal separation heads 16; 17 are arranged in the cutting area 20.

Furthermore, the two frame areas 18; 19 are preferably of a grid-like design and each have a plurality of high bars 21 extending in the height direction 15a and a plurality of crossbars 22 extending in the transverse direction 15b. The high bars 21 and the crossbars 22 are perpendicular to each other.

The crossbars 22 also form a rear wall 24 for abutment of the insulating glazing 1 to be separated and each comprise several rear wall rollers 23 for this purpose. The rear wall rollers 23 form an abutment plane 73 for the insulating glazing 1, in particular for the insulating glazing surface 1b facing the abutment plane 73. The abutment plane 73 is also parallel to the transverse direction 15b and the height direction 15a.

The rear wall rollers 23 of a crossbar 22 are arranged one behind the other in the transverse direction 15b. In addition, they are each rotatable about rear wall roller rotation axes 23a parallel to the height direction 15a. Preferably, the rear wall rollers 23 are freely rotatable.

The rear wall rollers 23 preferably comprise a soft plastic, preferably rubber, surface to prevent damage from scratches.

As an alternative to the crossbars 22, there may also be a panel, usually with a felt covering and rear wall rollers 23.

The rear wall 24 can also be designed as an air cushion wall in a manner known per se. It only needs to form an abutment plane 73 and enable movement of the insulating glazing 1 in the transport direction 45.

The base frame 15 also comprises a lower transport roller track 25 with several transport rollers 26. The transport rollers 26 are arranged one behind the other in the transverse direction 15b. The transport rollers 26 are also each rotatable about a transport roller rotation axis 26a perpendicular to the height direction 15a. The transport rollers 26 are freely or, at least partially, driven rotatable about the transport roller rotation axis 26a. The transport roller rotation axes 26a are perpendicular to the abutment plane 73 or slightly inclined, preferably by 0.1 to 3°, preferably by 0.1 to 0.5°, about an inclination axis perpendicular to the height direction 15a in a transport direction or feed direction 45 towards the abutment plane 73. The transport roller axes 26a thus preferably form an acute angle with the transport direction 45. The axis inclination in the transport direction 45 serves to better control the constant abutment of the insulating glazing 1 on the abutment plane 73. Because the insulating glazing 1 is thus always pushed slightly towards the abutment plane 73.

The upper horizontal separation head 16 is used to make horizontal separating cuts along an upper, horizontal insulating glazing edge 1c.

For this purpose, the upper horizontal separation head 16 comprises two rotary knives 27, two pressure rollers 28 and four positioning rollers 29, preferably a knife drive motor 30 and preferably a lubricating device for lubricating the rotary knife 27 with a, preferably liquid, lubricant, preferably, a preferably water-based or oil-based, lubricating emulsion.

The liquid lubricant can advantageously also be a lubricating oil or water. The advantage of using water as a lubricant is that it evaporates without leaving any residue. The lubricating oil can advantageously be a biodegradable lubricating oil.

The two pressure rollers 28 are each mounted rotatably about a pressure roller rotation axis 28a. The pressure rollers 28 are preferably freely rotatable about the pressure roller rotation axis 28a. According to a preferred embodiment, the pressure roller rotation axes 28a comprise an analogous axis inclination as the transport roller rotation axes 26a. The pressure roller rotation axes 28a are thus perpendicular to the abutment plane 73 or slightly inclined, preferably by 0.1 to 3°, preferably by 0.1 to 0.5°, about an inclination axis perpendicular to the height direction 15a in the transport direction or feed direction 45 towards the abutment plane 73. The pressure roller rotation axes 28a thus also preferably form an acute angle with the transport direction 45.

The pressure rollers 28 are pressed against the upper insulating glazing edge 1c during the separation process and roll along it. As a result, the insulating glazing 1 is guided in a clamped manner between the transport rollers 26 and the pressure rollers 28 during the separation process.

The two pressure rollers 28 are also arranged adjacent to and spaced apart from one another in the transverse direction 15b. Pressing on of the pressure rollers 28 comprises a position-independent adjustable force as its task. Preferably, the upper separation head 16 comprises pneumatic and/or magnetic and/or spring-loaded pressure means.

The two rotary knives 27 are used to cut through the primary seal 4 and the secondary seal 5 and thus to separate a respective glass pane 2 from the spacer tube 8. For this purpose, the rotary knives 27 are each rotatably mounted about a knife rotation axis 27a. In addition, the two rotary knives 27 are each connected to the knife drive motor 30 so that they are drivable about the respective knife rotation axis 27a. The two rotary knifes 27 are thus preferably drivable synchronously by the knife drive motor 30.

The knife rotation axis 27a is perpendicular to the insulating glazing surfaces 1a; 1b of the insulating glazing 1 to be cut, or preferably inclined by a first knife axis inclination axis 27-1 as well as by a second knife axis inclination axis 27-2 towards the respective glass pane surface 2b against which the rotary knife 27 abuts during the separation process.

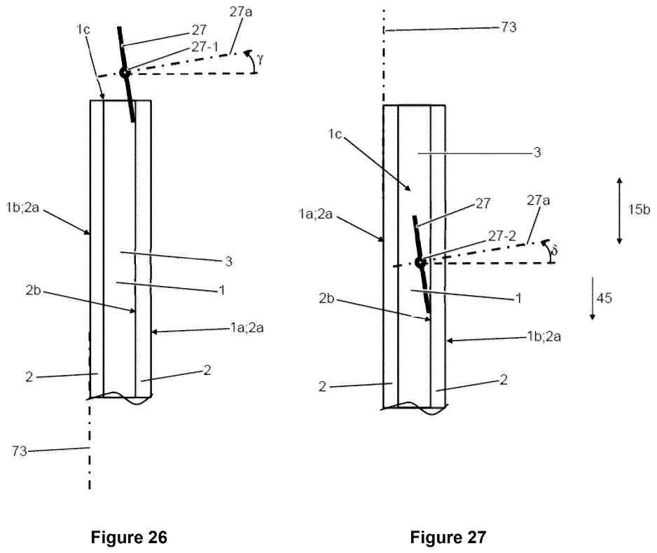

The first knife axis inclination axis 27-1 is parallel to the insulating glazing edge 1c along which the separation process takes place, i.e. parallel to the transverse direction 15b in the case of a horizontal separation process (FIG. 26). And a first acute angle of inclination γ about the first knife axis inclination axis 27-1 is preferably 0.05 to 5°, preferably 0.05 to 1.2°.

The second knife axis inclination axis 27-2 is perpendicular to the insulating glazing edge lc along which the separation process takes place and parallel to the abutment plane 73, i.e. parallel to the height direction 15a in the case of a horizontal separation process (FIG. 27). And a second acute angle of inclination δ about the second knife axis inclination axis 27-2 is preferably 0.05 to 3°, preferably 0.2 to 1.5°.

The two inclinations of the knife rotation axis 27a ensure that the rotary knife 27 is always in constant contact with the respective glass pane surface 2b and also always moves in between the spacer frame 3 and the glass pane surface 2a.

Preferably, the inclinations of the knife rotation axis 27a are adjusted in each case by inclining support plates 31a;b, on which the rotary knife 27 is mounted, about a corresponding inclination axis. The inclination is preferably set using adjusting screws 78; 79. A design with servomotors is also advantageous.

Preferably, the positioning rollers 29 and the knife drive motor 30 are also mounted on the support plates 31a;b.

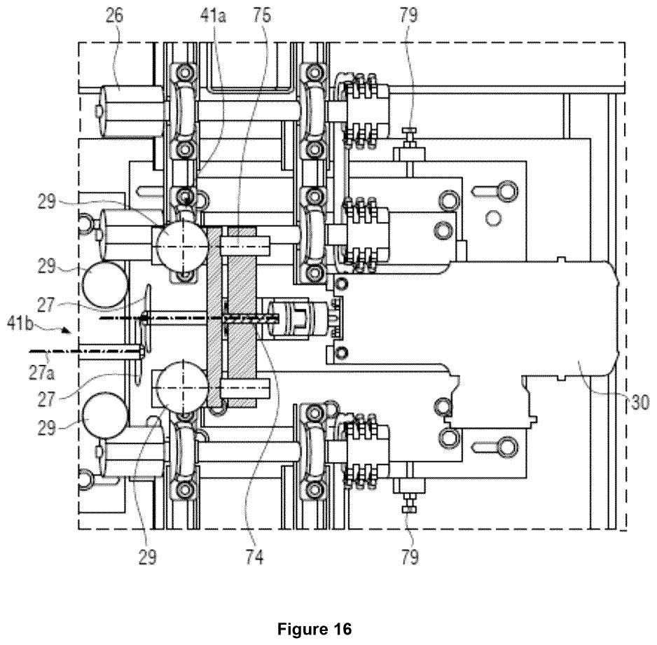

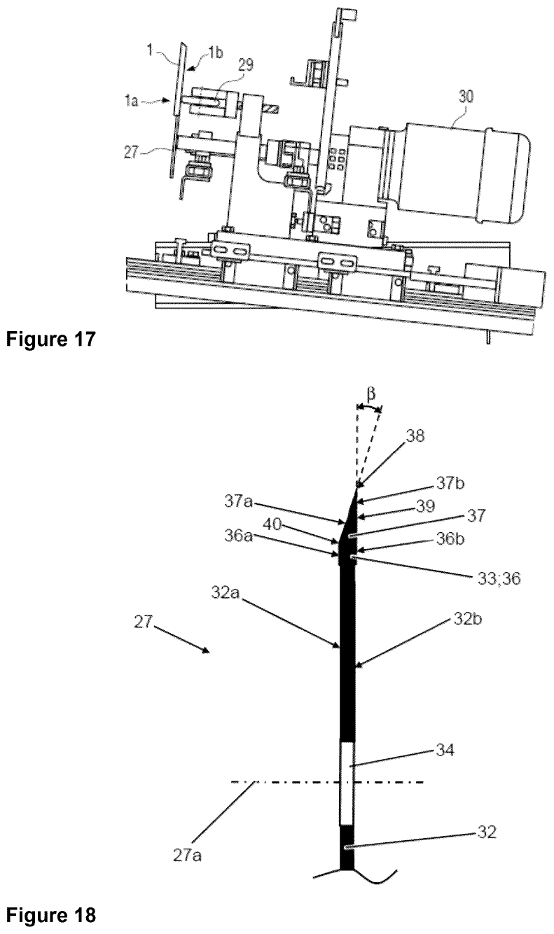

Furthermore, the two rotary knives 27 are each mounted together with the positioning rollers 29 so as to be movable or traversable, preferably drivable, back and forth towards and away from the abutment plane 73, preferably in a direction parallel to the knife rotation axis 27a. In addition, the two positioning rollers 29 are each connected to a drive means, preferably a servomotor, so as to be drivable relatively to the respective rotary knife 27, towards and away from the abutment plane 73, preferably in a direction parallel to the knife rotation axis 27a. Alternatively, an adjusting screw 74 (FIG. 16) can be provided for this purpose. This movability of the positioning rollers 29 in relation to the rotation knife 27 serves to adapt to the glass thickness of the respective glass pane 2 and to the width of the pane interspace 7.

The two rotary knives 27 are also preferably arranged offset to one another in the transverse direction 15b. This means that their knife rotation axes 27a are arranged offset to one another in the transverse direction 15b and are not coaxial to one another, but preferably at the same vertical height as viewed in the height direction 15a.

In addition, the two rotary knifes 27 are preferably located between the two pressure rollers 28 in the transverse direction 15b.

Furthermore, the two rotary knifes 27 are arranged on both sides of a center plane parallel to the abutment plane 73.

However, the knife rotation axes 27a can also advantageously be aligned with one another when viewed in the transverse direction 15b.

The knife rotation axes 27a are thus arranged symmetrically to the center plane according to an equally preferred embodiment.

The two rotary knives 27 are also preferably each rotationally symmetrical with respect to the knife rotation axis 27a. They are therefore preferably round knives or circular knives. However, it can also be a rotary knife 27 whose circumference is not circular but ellipsoidal.

A rotary knife 27 also comprises an inner knife basic body 32 and a knife blade 33 adjoining it in a radial outward direction.

The disk-like knife basic body 32 comprises two basic body surfaces 32a; 32b opposite each other in the direction of the knife rotation axis 27a. The basic body surfaces 32a; 32b are preferably planar and perpendicular to the knife rotation axis 27a. In addition, the knife basic body 32 comprises a central bearing recess 34 which extends through the knife basic body 32 from one basic body surface 32a; 32b to the other. The bearing recess 34 serves to support the rotary knife 27 on a knife drive shaft 35. The bearing recess 34 is designed in particular in such a way that positive torque transmission is ensured. In particular, the rotary knife 27 is non-rotatably connected to the knife drive shaft 35 about the knife rotation axis 27a. And the knife drive shaft 35 in turn is connected to the knife drive motor 30 so that it can be driven about the knife rotation axis 27a. The knife drive shaft 35 is also mounted so as to be rotatable about the knife rotation axis 27a and so as to be displaceable back and forth in the direction of the knife rotation axis 27a.

Preferably, the knife blade 33 comprises an annular blade section 36 and a circumferential cutting edge 37 adjoining it in a radial outward direction.

The annular blade section 36 comprises two, in particular planar, blade section surfaces 36a; 36b which are opposite each other in the direction of the knife rotation axis 27a. The blade section surfaces 36a; 36b are preferably planar and perpendicular to the knife rotation axis 27a.

The cutting edge 37 comprises a first and a second, in particular planar, circumferential cutting edge surface 37a; 37b, whereby the two cutting edge surfaces 37a; 37b merge into one another in a circumferential cutting edge ridge 38. The two cutting edge surfaces 37a; 37b form an acute cutting edge angle β. Preferably, the cutting edge angle β is 5 to 40°, preferably 10 to 30°.

In addition, the cutting edge ridge 38 is preferably not serrated or toothless.

The cutting edge 37 is therefore triangular in cross-section.

Furthermore, the second cutting edge surface 37b is perpendicular to the knife rotation axis 27a. And the first cutting edge surface 37b forms an obtuse angle with the knife rotation axis 27a.

The second cutting edge surface 37b is also preferably coplanar with the second blade section surface 36b, wherein the two surfaces 36b; 37b merge into one another and form a continuous blade contact surface 39.

And the first cutting edge surface 37a merges into the first blade section surface 36a via a circumferential transition edge 40.

According to one embodiment, the knife blade 33 also comprises a slightly greater thickness than the knife basic body 32. The thickness corresponds to the extension in the direction of the knife rotation axis 27a.

Thereby, the first blade section surface 36a protrudes above the first basic body surface 32a and the second blade section surface 36b protrudes above the second basic body surface 32b.

Preferably, however, the first blade portion surface 36a and the first basic body surface 32a as well as the second blade portion surface 36b and the second basic body surface 32b respectively are coplanar with each other.

In the former case, the knife blade 33 thus protrudes beyond the knife basic body 32 on both sides, but at least with the blade contact surface 39, as seen in the direction of the knife rotation axis 27a. This protects the inner glass pane surface 2b, since only the blade contact surface 39, but not the knife basic body 32, is in contact with the inner glass pane surface 2b. If necessary, the knife blade 33 protrudes on one side by 20 to 150 μm, preferably 50 to 100 μm, over the knife basic body 32.

Preferably, the knife blade 33 also comprises a thickness of 0.2 to 1 mm, preferably 0.3 to 0.6 mm.

And/or the knife basic body 32 preferably comprises a thickness of 0.2 to 0.8 mm, preferably 0.3 to 0.5 mm.

The rotary knife 27 also preferably comprises a diameter of 60 to 100 mm, preferably 70 to 90 mm.

Furthermore, the rotary knife 27 is preferably made of bendable metal, preferably bendable steel. This allows the rotary knife 27 to twist during the separation process and to nestle against the glass pane surface 2b, which ensures very clean removal of the primary and secondary seals 4;5 from the glass pane surface 2b. At the same time, the glass pane surface 2b is not damaged.

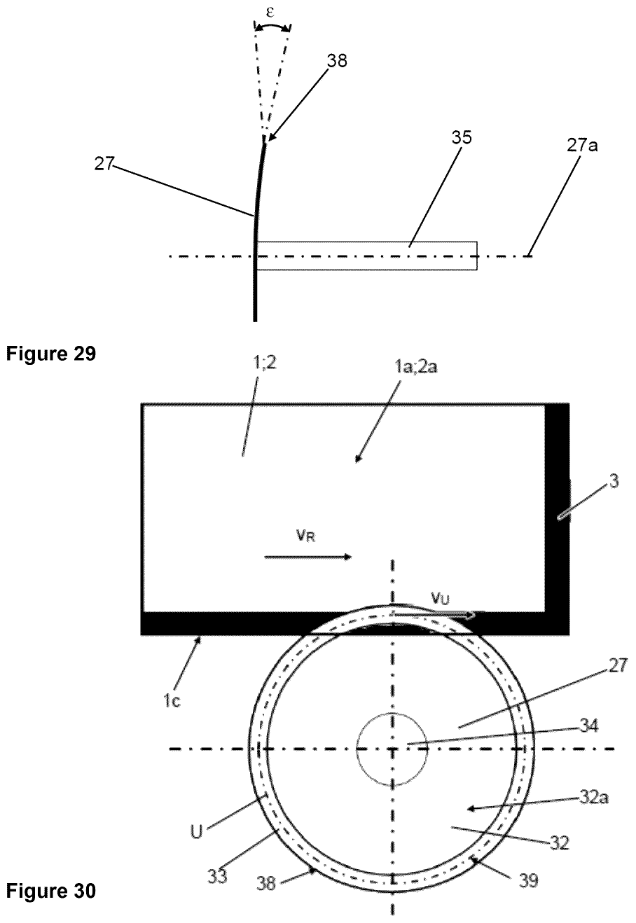

In particular, it is important that the knife blade 33 comprises a corresponding flexibility. Preferably, the knife blade 33 can be bent elastically reformable by a bending angle ε (FIG. 29). The bending angle ε corresponds to the angle between a tangent in the area of the cutting edge ridge 38 and a plane perpendicular to the knife rotation axis 27a. Preferably, the bending angle ε is at least 5°, preferably at least 15°, particularly preferably at least 20°, most preferably at least 30°.

In addition, the rotary knife 27 preferably comprises a static rigidity of 3 to 25 N/mm, preferably 5 to 20 N/mm.

To determine the static rigidity, the rotary knife 27 is clamped over a diameter of 30 mm and the test force is applied at a distance of 12 mm from the cutting edge ridge 38.

As already explained, the upper horizontal separation head 16 also comprises four positioning rollers 29.

Thereby, two positioning rollers 29 respectively interact with or are assigned to a rotary knife 27. The horizontal separation head 16 thus comprises a first and a second cutting combination 41a; 41b, each consisting of two positioning rollers 29 and a rotary knife 27.

The positioning rollers 29 are used to position the respective rotary knife 27 of a cutting combination 41a; 41b relative to the insulating glazing 1 to be cut, in particular to guide the respective rotary knife 27 equidistantly to the outer glass pane surface 2a or insulating glazing surface 1. Viewed in the transverse direction 15b, they are arranged on both sides of the rotary knife 27 to be positioned. This means that a positioning roller 29 is arranged on each side of the respective rotary knife 27 as viewed in the transverse direction 15b. Preferably, they are also arranged between the two pressure rollers 28 as viewed in the transverse direction 15b and preferably slightly below them.

The positioning rollers 29 are each mounted to rotate about a positioning roller rotation axis 29a in such a way that they can roll along the insulating glazing surface 1b facing the abutment plane 73 during the separation process.

The positioning roller rotation axes 29a are therefore preferably at least substantially parallel to the height direction 15a. The positioning rollers 29 are preferably freely rotatable about the positioning roller rotation axis 29a.

The positioning rollers 29 are also displaceable parallel to the knife rotation axis 27a together with the rotary knife 27. In particular, they or the cutting combination 41; 41b together with the rotary knife 27 are connected to drive means, preferably pneumatic cylinders 75 (FIG. 16), so as to be drivable back and forth in a direction perpendicular to the abutment plane 73.

During the separation process, the positioning rollers 29 abut against one of the two insulating glazing surfaces 1a; 1b of the insulating glazing 1 to be separated and roll on it.

The two positioning rollers 29 are arranged on the side of the blade contact surface 39 of the rotary knife 27 and are spaced apart from the latter in a direction parallel to the knife rotation axis 27a. In particular, the distance between the blade contact surface 39 and the positioning rollers 29, in particular an outer surface line of the positioning rollers 29, can be adjusted by adjusting the positioning rollers 29 so that it always corresponds to the thickness of the glass sheet 2 against which the two positioning rollers 29 are in contact during separating. This ensures the precise positioning of the rotary knife 27 relative to the glass pane 2 during the separation process, even if the insulating glass 12 does not lie completely flat against the rear wall rollers 23 during the cutting process.

Furthermore, the two cutting combinations 41a; 41b are arranged on both sides of the center plane parallel to the abutment plane 73 and are preferably designed symmetrical with respect thereto. This means that the first combination 41a is arranged on one side of the center plane and the second combination 41b is arranged on the other side of the center plane.

Like the rear wall rollers 23, the positioning rollers 29 preferably comprise a soft plastic, preferably rubber, surface in order to prevent damage from scratches.

The upper horizontal separation head 16 is also movable back and forth along the base frame 15 in a direction parallel to the height direction 15a. A separation head height positioning motor 42 is provided for vertical positioning of the horizontal separation head 16. This allows insulating glazing units 1 with different heights to be separated.

As already explained, the separation device 14 also comprises the lower horizontal separation head 17. This is preferably stationary in relation to the base frame 15 and mounted on it. It is therefore stationary.

The lower horizontal separation head 17 is also designed essentially in the same way as the upper horizontal separation head and comprises two rotary knives 27 and four positioning rollers 29. However, it has no pressure rollers 28, as the insulating glazing 1 rests on the transport rollers 26 at the bottom. The positioning rollers 29 are also arranged above the transport roller track 25.

In addition, the lower horizontal separation head 17 comprises a press-on roller 43, which is used to position the insulating glazing 1 on the transport roller track 25.

The press-on roller 43 is rotatably mounted about a press-on roller rotation axis 43a parallel to the height direction 15a. The press-on roller 43 is preferably freely rotatable about the press-on roller rotation axis. In particular, the press-on roller rotation axis is parallel to the rear wall roller rotation axes 23a of the rear wall rollers 23.

The press-on roller 43 is also displaceable or moveable perpendicularly to the abutment plane 73. In particular, it is connected to drive means, preferably a pneumatic cylinder 44, so as to be driveable back and forth in a direction perpendicular to the abutment plane 73.

The press-on roller 43 is also arranged in such a way that it can be pressed against the front glass pane 2 opposite the rear wall rollers 26 in the area of the lower pane outer edge 2c of the insulating glazing 1. Or it is pressed against the insulating glazing surface 1a and rolls against it. As a result, the insulating glazing 1 is displaced on the transport roller track 25 until it rests against the rear wall rollers 23.

The press-on roller 43 is therefore arranged upstream of the two combinations 41a; 41b, as seen in a feed direction 45 parallel to the transverse direction 15b. This means that if the insulating glazing 1 is moved in the feed direction 45, it first comes into engagement with the press-on roller 43.

A pneumatic cylinder is preferably used to position and apply a constant, adjustable force to the press-on roller 43.

In the following, the separation process according to the invention is explained in more detail using double insulating glazing as an example:
First, an insulating glazing unit 1 to be disassembled is fed into the receiving area 18 (FIG.
2). In particular, the insulating glazing 1 is placed with its lower insulating glazing edge 1c on the transport roller track 25 and partially placed against the rear wall rollers 23.

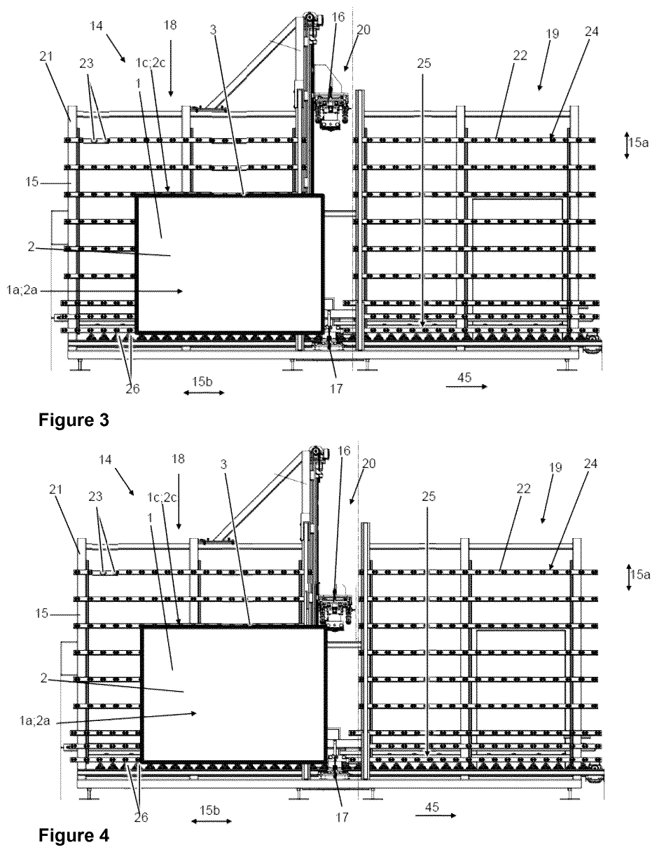

The insulating glazing 1 is then moved on the transport roller track 25 in the feed direction 45 to the cutting area 20 (FIG. 3). This is preferably done by driving the insulating glazing by means of the transport rollers 26. The insulating glazing 1 is first moved until the press-on roller 43 comes into engagement with the glass pane surface 2a of the front glass pane 2 or with the insulating glazing surface 1a. As a result, the insulating glazing 1 is moved along the transport roller track 25 until it rests against the rear wall rollers 23 at the position of the press-on roller 43.

The upper horizontal separation head 16 is then moved downwards until the first of the two pressure rollers 28 touches the upper insulating glazing edge 1c (FIG. 4). By this the insulating glazing 1 is clamped between the pressure roller 28 and the transport rollers 26 and positioned in the height direction 15a.

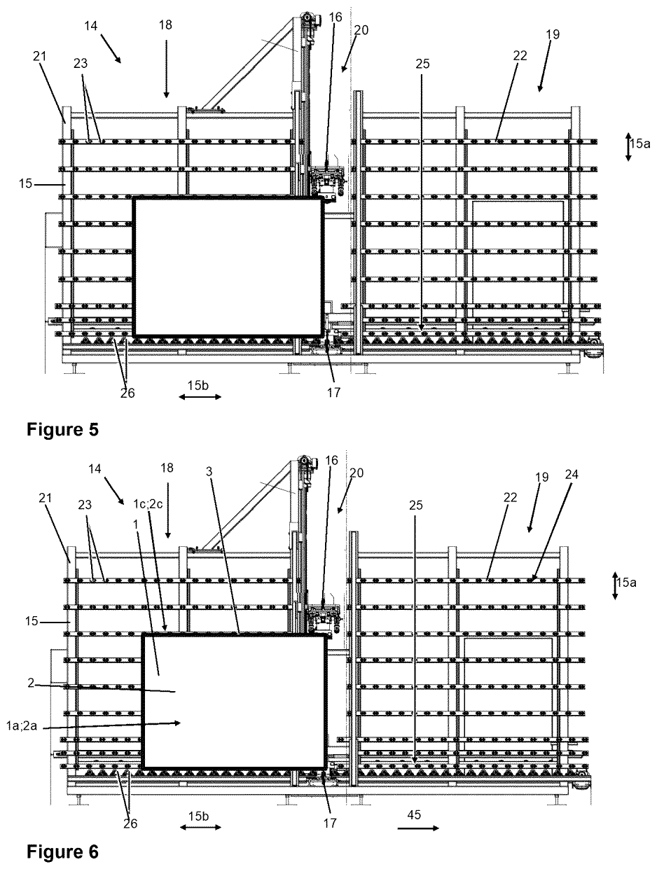

The insulating glazing 1 is then moved slightly in the feed direction 45 until it is positioned in front of the first rotary knife 27 (FIG. 5). The rear cutting combinations 41a of the upper and lower horizontal separation heads 16; 17 are now moved towards the insulating glazing 1 until the first of the two positioning rollers 29 is in contact with the outer glass pane surface 2a of the rear glass pane 2.

The insulating glazing 1 is then moved slightly further in the feed direction 45 until it is positioned in front of the second rotary knife 27 (FIG. 6). The front cutting combinations 41b of the upper and lower horizontal separation heads 16; 17 are now moved towards the insulating glazing 1 until the first of the two positioning rollers 29 of the front cutting combinations 41b is in contact with the outer glass pane surface 2a of the front glass pane 2.

The distance of the positioning rollers 29 from the respective circular knives 27, which corresponds to the respective glass pane thickness, has already been set beforehand. Preferably, the glass pane thicknesses and/or the insulating glazing thickness are entered beforehand on a user interface of a control device (not shown) and set via the servomotor or the adjusting screw 74.

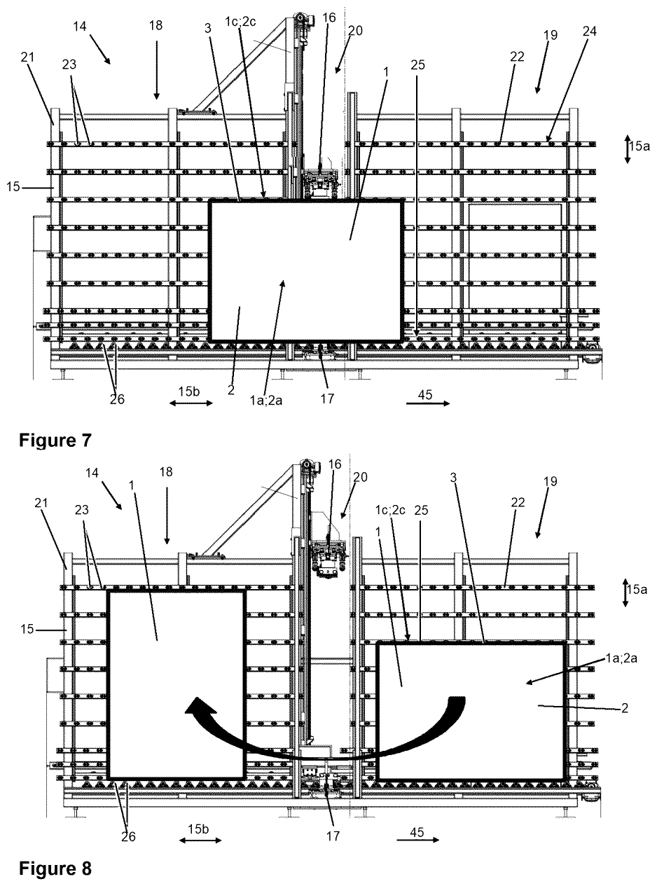

The actual separation process then takes place (FIG. 7). For this purpose, the insulating glazing 1 is moved further in the feed direction 45 until it has completely passed through the cutting area 20 and is positioned in the removal area 19.

During the passage through the cutting area 20, the spacer frame 3 is separated from the two glass panes 2 by means of the rotary knives 27 in the area of the upper and lower insulating glazing edge 1c. For this purpose, the rotary knives 27 move with the knife blade 33 into the area between the respective inner glass pane surface 2b and the spacer frame 3, thereby cutting the primary and secondary seals 4;5. Penetration is facilitated by the transition walls 13 of the spacer frame 3 and, if necessary, by reinforced over walls at the corners of the curved spacer tube 8, as these act as insertion funnels.

During the separation process, the rotary knifes 27 are driven by the knife drive motor 30 in such a way that they rotate about the knife rotation axes 27a.

The rotary knives 27 are aligned in such a way that the blade contact surface 39 faces the inner glass pane surface 2b and rests against it or slides along it or fits snugly against it. The flexibility of the rotary knifes 27 supports the threading process and compensates for irregularities during the separation process.

Preferably, the feed speed of the insulating glazing 1 is set in such a way that a neutral circumferential line U is present on the blade contact surface 39, along which the relative speed in a direction parallel to the insulating glazing edge 1c between the blade contact surface 39 and the glass pane surface 2b, against which the blade contact surface 39 rests, is essentially 0.

The circumferential speed vu of the blade contact surface 39 in the area of the neutral circumferential line U therefore corresponds to the feed speed of the insulating glazing 1 or, more generally, it corresponds to the relative speed v_{R} between the rotary knife 27 and the glass pane 2 in a direction parallel to the insulating glazing edge 1c. The circumferential line U extends rotationally symmetrically around the knife rotation axis 27a.

This ensures very gentle separation. In particular, the glass pane surface 2b is hardly scratched. Minimal movement relative to the inner glass pane surface 2b is ensured.

This is also realized in particular by the fact that the insulating glazing 1 is driven in the feed direction 45 mainly by means of the rotary knifes 27. Depending on the weight of the insulating glazing 1, it is also driven by the transport rollers 26, but this drive can also be omitted.

During the separation process, the rotary knifes 27 are also preferably lubricated by means of the lubricants in order to minimize friction during the separation process.

When the insulating glazing 1 has arrived in the removal area 19, the upper horizontal separation head 16 moves upwards and the insulating glazing 1 is rotated, in particular manually, by 90° around an axis perpendicular to the height direction 15a and returned to the receiving area 18, where it is placed on the transport roller track 25 (FIG. 8).

The separation process described above is then repeated so that the spacer 3 is also separated from the two glass panes 2 at the other two insulating glazing edges 1a. The spacer 3 can now be removed and the glass panes 2 can be used further.

For pure recycling of glass, a high-quality, unmixed raw material, nearly free of metal and drying agents, has been obtained.

For upcycling, the edge can now either be removed using conventional cutting technology or, in order to retain the glass pane 2 as a whole, the remains of the primary and secondary seal 4; 5 and/or the lubricant adhering to the inner glass pane surfaces 2b must be removed at least beforehand. This can be done manually, for example, using scrapers and/or a high-pressure cleaner and/or brushes. As a rule, in case of use of lubricant during the separation process, a high-pressure cleaner is sufficient for removing. The removal of any residues of the primary and secondary seal 4; 5 and/or the lubricant can also be carried out using a solvent, e.g. isopropanol.

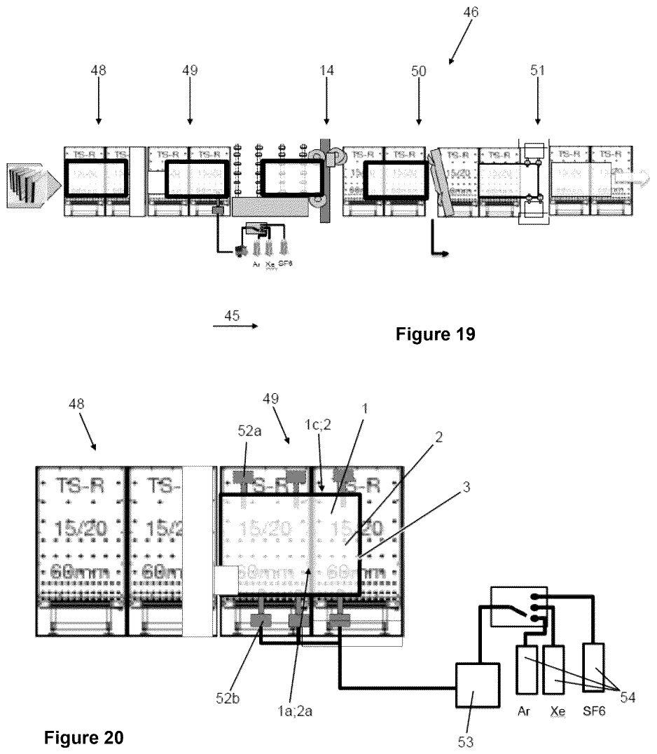

As already explained, the separation device 14 according to one embodiment of the invention is integrated into a reprocessing device 46 (FIG. 19) for the automated reprocessing of insulating glazing units 1.

The reprocessing device 46 comprises an inspection device 48, a degassing device 49, the separation device 14 according to the invention and a sealing residue removal device 51 arranged one behind the other in a reprocessing feed direction 47.

The inspection device 48 is used to determine certain properties of the insulating glazing units 1 to be disassembled, in particular to measure the insulating glazing units 1 to be disassembled. In particular, the inspection device 48 comprises means for measuring the thickness, width and length of the insulating glazing 1. Preferably, the inspection device 48 also comprises means for measuring the structure of the insulating glazing 1.

In particular, it is determined whether it is a double or triple insulating glazing 1. In addition, the thickness of the individual glass panes 2 of the insulating glazing 1, the thickness of the spacer frame 3 and preferably the presence of functional coatings on the glass pane surfaces 2a;b can be determined. It may also be possible to determine which gas the insulating glazing 1 is filled with.

The means for measuring the insulating glass structure are known to the skilled man, e.g. https://www.sparklik.com/en/products/sparklike-laser-integrated or the GlassBuddy® from Bohle AG.

The degassing device 49 (FIG. 20) comprises several drilling devices 52 for drilling through the secondary seal 5 and the spacer frame 3. Preferably, a plurality of upper drilling devices 52a are present, which are arranged along the upper insulating glazing edge 1c, and a plurality of lower drilling devices 52b are also present, which are arranged along the lower insulating glazing edge 1a. The lower drilling devices 52b are also preferably connected to a suction device 53, with which the gas located in the pane interspace 7 is sucked out of the pane interspace 7.

The gases present in the pane interspace 7 can be argon, xenon or sulfur hexafluoride (SF₆), for example. As these are heavier than air, they are preferably extracted at the lower drilling devices 52b. After extraction, the gases are then filled into corresponding gas storage devices 54.

As already explained, the separation device 14 follows to the degassing device 49.

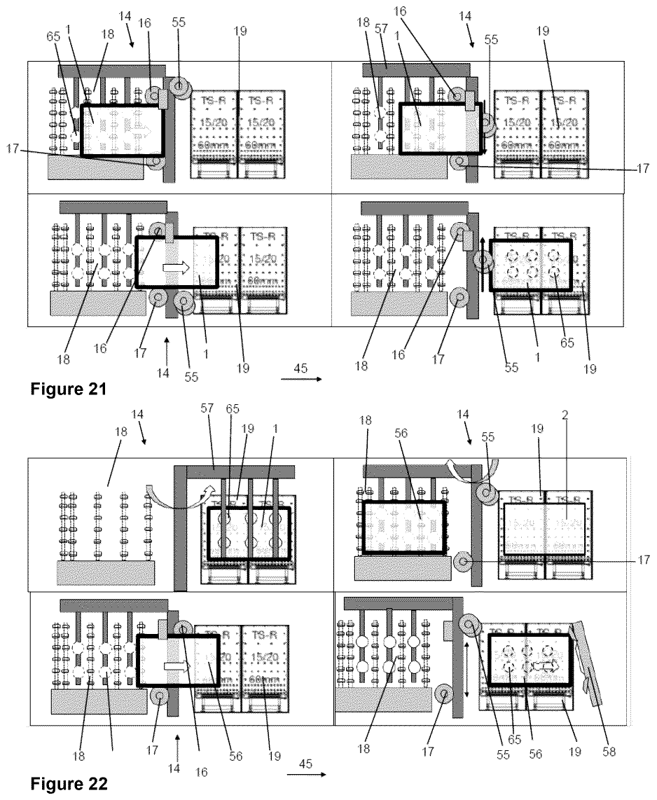

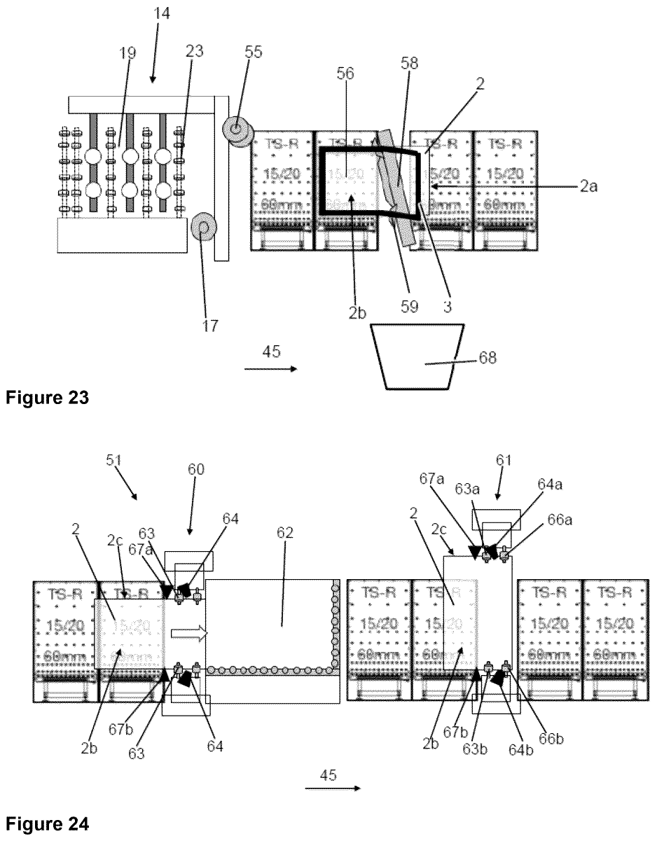

The separation device 14 (FIGS. 21-23) not only comprises the upper, movable horizontal separation head 16 and the lower, fixed horizontal separation head 17, but also a further, also movable, vertical separation head 55. The vertical separation head 55 is used for separating in a direction parallel to the height direction 15a or along an insulating glazing edge 1c extending parallel to the height direction 15a.

According to a first embodiment, the vertical separation head 55 is designed analogously to the upper horizontal separation head 16 described in the context of the first exemplary embodiment and comprises two cutting combinations 41a; 41b, each with a rotary knife 27 and two positioning rollers 29.

In addition, the vertical separation head 55 can comprise a fall protection roller (not shown), preferably designed in the same way as the press-on roller 43, which serves to prevent the glass from tipping forward.

However, the vertical separation head 55 is rotatable about an axis perpendicular to the height direction 15a and the transverse direction 15b or an axis perpendicular to the insulating glazing surfaces 1a;1b compared to the upper horizontal separation head 16, so that it can be used for separating along both vertical insulating glazing edges 1c. In particular, the vertical separation head 55 is arranged rotated clockwise by 90° in comparison to the upper horizontal separation head 16 about the axis perpendicular to the height direction 15a and the transverse direction 15b or the axis perpendicular to the insulating glazing surfaces 1a;1b during the separation process.

According to a further embodiment, the vertical separation head 55 comprises two cutting combinations 41a; 41b for each of the two insulating glazing edges 1c. Because of that the vertical separation head 55 does not have to be rotated.

Alternatively, a cutting combination 41a; 41b comprises a pair of positioning rollers 29 for each of the two insulating glazing edges 1c, wherein only one pair of positioning rollers is engaged during the separation process. The two pairs of positioning rollers are arranged opposite each other when viewed in the transverse direction 15b. In other words, one pair of positioning rollers is arranged on one side of the respective rotary knife 27 as viewed in the transverse direction 15b and the other pair of positioning rollers is arranged on the other side of the rotary knife 27 as viewed in the transverse direction 15b.

In this embodiment, too, the vertical separation head 55 does not have to be rotated so that separation can take place along both insulating glazing edges 1c. Furthermore, if the knife rotation axes 27a are not perpendicular to the abutment plane 73 in this embodiment, the rotary knifes 27 can be adjusted, in particular by means of corresponding drive means, in such a way that the knife rotation axes 27a always comprise the corresponding inclination to the insulating glazing edge 1c and to the glass pane surface 2b during the separation process.

Furthermore, the vertical separation head 55 is also mounted on the base frame 15 so as to be movable back and forth in a direction parallel to the height direction 15a. The vertical separation head 55 also comprises a separation head drive motor 42, with which the vertical separation head 55 is connected so as to be drivable back and forth in the height direction 15a.

Furthermore, in the embodiment of the separation device 14 for the reprocessing device 46, it is sufficient if the upper horizontal separation head 16 and the lower horizontal separation head 17 only comprise a single cutting combination 41a, which serves to separate the rear glass pane 2, which is in contact with the rear wall rollers 23, from the spacer frame 3, which is explained in more detail below.

The vertical separation head 55 is also arranged after the first and second horizontal separation heads 16; 17 as seen in the feed direction 45. This means that when the insulating glazing 1 is moved in the feed direction 45, it first encounters the two horizontal separation heads 16; 17.

The automated separation process preferably proceeds as follows:

First, the insulating glazing 1 to be disassembled is moved in the feed direction 45 as described above, so that it comes into engagement with both the upper horizontal separation head 16 and the lower horizontal separation head 17 and the spacer frame 3 is separated in a first section or in a first partial area.

The insulating glazing 1 is then stopped and the vertical separation head 55 moves downwards and the corresponding positioning rollers 29 of the vertical separation head 55 are moved towards the two insulating glazing surfaces 1a; 1b. The vertical separation head 55 then moves from top to bottom, separating the spacer frame 3 on both sides from the two glass panes 2 in the area of the first vertical or essentially vertical insulating glazing edge 1c, which extends parallel to the height direction 15a.

As soon as this vertical separation process is completed, the insulating glazing 1 is moved further in the feed direction 45 and the horizontal separation process is continued and completed.

The insulating glazing 1 is then stopped and the vertical separation head 55 moves upwards and the corresponding positioning rollers 29 of the vertical separation head 55 are again moved towards the two insulating glazing surfaces 1a; 1b. The vertical separation head 55 then moves upwards from below, separating the spacer frame 3 on both sides from the two glass panes 2 in the area of the second vertical or essentially vertical insulating glazing edge 1c, which extends parallel to the height direction 15a.

During the vertical separation processes, the insulating glazing 1 is preferably fixed or held in place by vacuum suction cups 65.

Since the two horizontal separation heads 16;17 only comprise a single cutting combination 41a, only the rear glass pane 2 resting against the rear wall 24 is separated from the spacer frame 3 along the two horizontal insulating glazing edges 1c.

Since the rear glass pane 2 is now completely separated from the spacer frame 3, it is separated from a remaining insulating glazing element 56 comprising the front glass pane 2 and the spacer frame 3.

For example, this is done by means of a gripping device 57. The gripping device 57 preferably also comprises vacuum grippers 65 for this purpose, which grip the front glass pane 2 and rotate the insulating glazing element 56 through 180° about an axis perpendicular to the glass pane surface 2a; 2b and set it down on the receiving area 18, while the rear glass pane 2 is held by the vacuum suction cups 65 which are installed in the rear wall 24.

Preferably during swiveling of one glass pane 2, the separated glass pane 2 is transported out.

After rotation, the glass pane 2 of the insulating glazing element 56 lies with its outer glass pane surface 2a against the rear wall 24.

The spacer frame 3 is then at least partially separated from the glass pane 2 by means of the upper and lower horizontal separation head 16; 17. Preferably, the upper rotary knife 27 only cuts the secondary seal 5 and not the primary seal 4 in order to ensure that the spacer frame 3 is still connected to the glass pane 2.

The final separation of the spacer frame 3 from the glass pane 2 is then preferably carried out by means of a frame knife 58, which is arranged in the removal area 19. For this purpose, the, preferably fixed, frame knife 58 comprises an upper and optionally a lower, in each case flexible, knife blade 59. To cut off the spacer frame 3, the insulating glazing element 56 is also pushed through the fixed knife blades 59 in the feed direction 45. By this, the second glass pane 2 is also completely separated from the spacer frame 3. Due to an advantageous curvature of the frame blade out of the abutment plane 73, the spacer frame 3 is bent forwards and drops forwards into the disposal.

The final separation can also be achieved, for example, by pulling the spacer frame 3 and the glass pane 2 apart.

After separation, the spacer frame 3 is preferably fed to a crusher 68 in order to increase the packing density. The crusher 68 can be arranged directly below the separation device 14, for example. Or the spacer frames 3 are transported to the crusher 68 by means of a conveyor, e.g. a conveyor belt or a conveyor carriage.

As already explained, the sealing residues of the primary and secondary seal 4; 5 adhering to the separated glass panes 2 must now be removed. This is done in the sealing residue removal device 51 (FIG. 24), which follows the separation device 14.

The sealing residue removal device 51 comprises a first cleaning station 60, a second cleaning station 61 and a vertical pane turning device 62 in between.

The first and second cleaning stations 60; 61 each preferably comprise an upper and a lower scraper 67a;b, a first upper and a first lower metal brush 63;b, an upper and lower cleaning nozzle 64a;b to which high-pressure water is applied, and a second upper and a second lower metal brush 66a;b for removing the residues of the primary and secondary sealing residues. The metal brushes 63a;b; 66a;b are preferably steel brushes. Preferably, the first metal brushes 63a;b serve to remove the secondary sealing residues and the second metal brushes 66a; b serve for subsequent cleaning over the area of the primary and secondary seals 4; 5. The cleaning nozzles 64a; b serve primarily to remove the primary seal residues. And the scrapers 67a;b are used for pre-cleaning, in particular for removing large secondary sealing residues. Sand can also be advantageously added to the high-pressure water.

In the first cleaning station 60, the primary and secondary sealing residues are thus removed along the two first, horizontal pane outer edges 2c. The glass pane 2 is then tilted by 90° using the tilting table 62 and the primary and secondary sealing residues are removed in the area of the two other, then also horizontal, outer pane edges 2c in the second cleaning station 61. The cleaned glass pane 2 can then be removed from the sealing residue removal device 51 and fed to the desired recycling process.

Disassembling of triple insulating glazing units is carried out in the same way as of the double insulating glazing 1. First, only one glass pane 2 and one spacer frame 3 are separated and then the remaining double insulating glazing is disassembled as described.

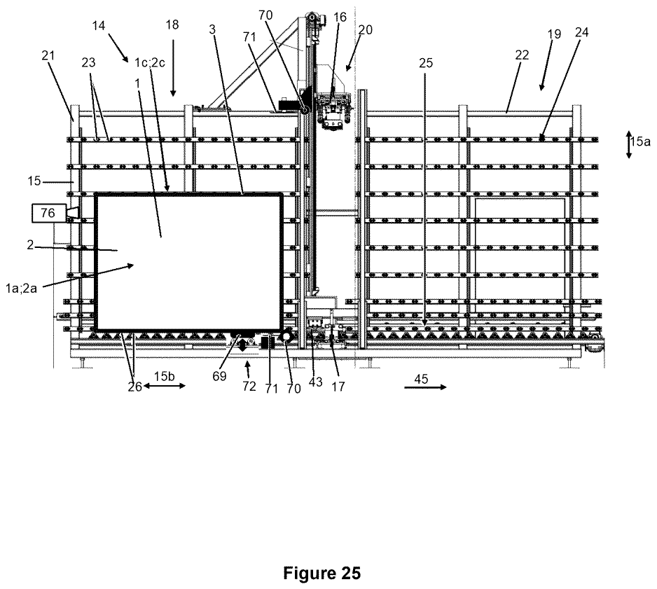

According to a further embodiment of the invention (FIG. 25), the separation device 14 also comprises edge conditioning means for removing impurities from the insulating glazing edges 1c before the separation process. The impurities are, for example, glass chips and/or glass fragments and/or distant pieces 69 which may still adhere to the outside of the insulating glazing edge 1c from the installation of the insulating glazing 1.

For example, the separation device 14 for removing glass chips and/or glass fragments comprises a brush roller 70 at the top and at the bottom, which is rotatable and preferably drivable with corresponding drive means about a rotation axis perpendicular to the abutment plane 73.

In addition, the separation device 14 preferably comprises an edge conditioning rotary knife 71 at the top and bottom, which is rotatable, preferably freely rotatable, about a rotation axis parallel to the height direction 15a. The edge conditioning rotary knife 71 is used to cut off the distant pieces 69.

In order to ensure positioning of the lower edge conditioning rotary knife 71 in the height direction 15a relative to the insulating glazing edge 1c, the transport roller track 25 also comprises a lowerable transport roller track section 72 with several transport rollers 26. The transport roller track section 72 is positioned such that the distant piece 69 to be cut off is positioned thereon shortly before the edge conditioning rotary knife 71 engages. Due to the fact that the transport roller track section 72 is lowered relative to the other transport rollers 26, the insulating glazing 1 continues to rest on the other transport rollers 26.

The upper edge conditioning rotary knife 71 and the upper brush roller 70 are also movable parallel to the height direction 15a, in particular together with the upper separation head 16.

The edge conditioning means described above are used to clean the horizontal insulating glazing edges 1c. If necessary, the separation device 14 also comprises corresponding edge conditioning means for the vertical insulating glazing edges 1c, which are attached to the vertical separation head 55, for example.

Conditioning of the insulating glazing edges 1c serves to avoid excessive stress on the rotary knifes 27 and to prevent damage resulting therefrom such as warping and/or chipping and/or breakage.

In addition, the separation device 14 preferably comprises a camera 76 for measuring the glass pane thickness and/or the insulating glazing thickness. This allows the distance of the positioning rollers 29 from the respective circular knife 27 to be set automatically.

The separation device 14 can also comprise further means for removing contamination and interfering contours, for example sealing residues on the insulating glazing surfaces 1a;b or bulges and stuck parts on the secondary seal 5. However, these means can also be present in a separate device.

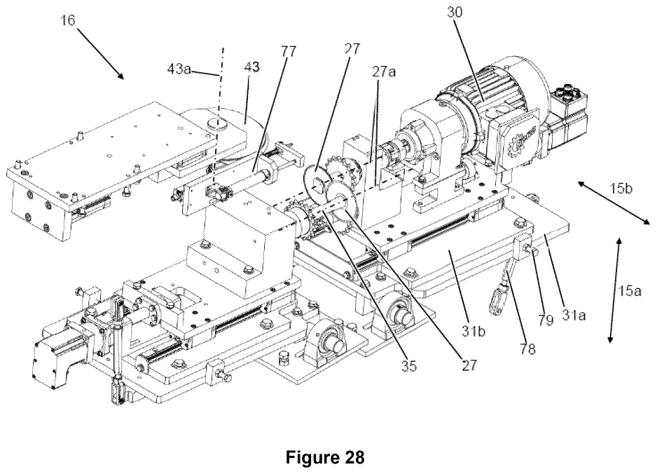

According to a further embodiment of the invention (FIG. 28), the separation heads 16; 17; 55 comprise no positioning rollers 29, but only a press-on roller 43. The upper horizontal separation head 16 thus also comprises a press-on roller 43. The circular knives 27 are preferably connected to a drive means, preferably an actuator, so as to be movable back and forth parallel to the knife rotation axis.

In addition, the lower horizontal separation head 17 comprises a measuring head 77 for measuring the thickness of the insulating glazing. The measuring head 77 preferably comprises a caliper for measuring, which is pressed against the insulating glazing surface 1a by a pneumatic cylinder. By this the relative position of the first rotary knife 27 to the insulating glazing surface 1a is determined when the glass thickness is known. If the set axial position of the rotary knife 27 is not correct for the cut, the rotary knife 27 is moved in the axial direction until the rotary knife 27 is in the correct position.

The measuring head 77 therefore serves in particular to check whether the insulating glazing surface 1a and thus the insulating glazing 1 is in its target position and thus in particular to check whether the insulating glazing thickness is correctly stored and/or whether the insulating glazing 1 is correctly positioned on the rear wall 24 and/or whether the position of the rotary knifes 27 needs to be readjusted.

In an alternative embodiment, not shown, the caliper is combined or connected with the press-on roller 43 and the measurement takes place while the insulating glazing 1 is pressed against the rear wall 24 and during the separation process.

The separation process according to the invention then proceeds as follows:
Preferably, the glass thicknesses and insulating glazing thicknesses are entered on the user interface first. The two rotary knives 27 are then moved in an axial direction to their respective cutting position.

The insulating glazing 1 is then positioned against the rear wall 24 as described above by means of the two press-on rollers 43 of the lower horizontal separation head 17 and the upper horizontal separation head 16.

Then, as already described, the upper horizontal separation head 16 is moved downwards until the first of the two pressure rollers 28 abuts against the upper insulating glazing edge 1a.

The insulating glazing 1 is then moved slightly in the feed direction 45 until it is positioned in front of the first rotary knife 27 (FIG. 5). The insulating glazing thickness is now measured by means of the measuring head 77 and, if necessary, the first rotary knife 27 and, if necessary, the second rotary knife 27 are readjusted to their respective cutting position in the direction parallel to the knife rotation axis 27a on the basis of the measurement results.

If the measurement results deviate from the previous entries, a corresponding alarm can also be sent to the operator.

The separation process is then carried out as described above.

It is also within the scope of the invention to provide only one positioning roller 29 or that only one of the two positioning rollers is in contact during the separation process.

Furthermore, it is of course also within the scope of the invention that during disassembly the spacer frame 3 is not completely separated from the glass pane 2 at only one edge, in particular only at the upper horizontal edge. In this case, it is sufficient if the frame knife 58 only comprises the upper knife blade 59a.

Furthermore, it is within the scope of the invention that the separation along the insulating glazing edges 1c takes place in a different order than described.

In addition, the rotary knifes 27 do not have to be driven about their knife rotation axis 27a by the knife drive motor 30, even if this is preferred. The non-driven rotary knife 27 rolls during the separation process and thus rotates. For example, only a part of the rotary knives 27 can be driven.

Furthermore, instead of the preferred stationary separation device 14, the separation device 14 can also be a portable hand-held device (not shown), which comprises a single rotary knife 27. The hand-held device also comprises at least one handle and the knife drive motor.

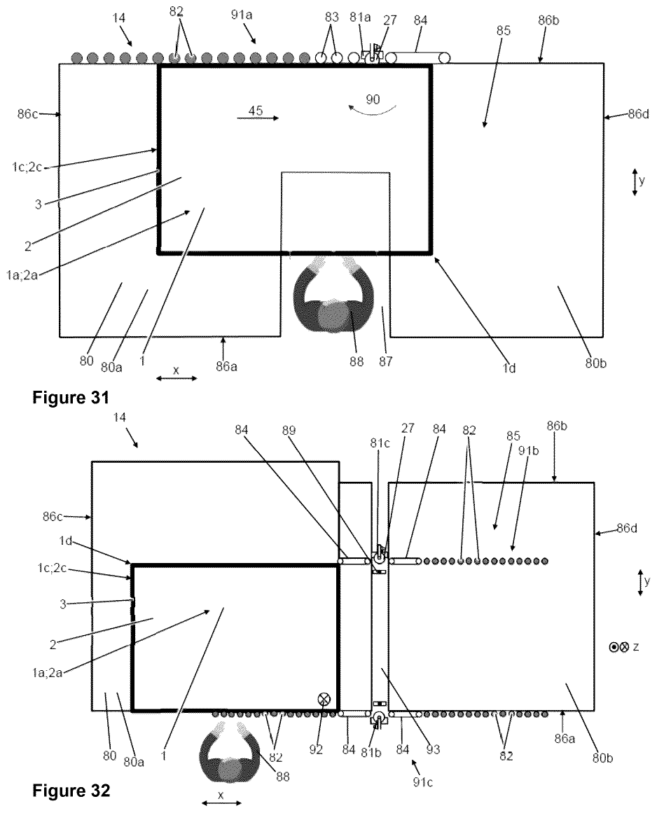

In addition, the separation device 14 can also be designed for separation of a glass pane 2 of a lying or horizontally arranged insulating glazing 1 (FIG. 31 to 42).

Such a separation device 14, in which the insulating glazing 1 is arranged in a lying manner during the separation process, is also referred to below as a horizontal separation device 14, even if the insulating glazing 1 is not arranged completely horizontally.

According to a first embodiment (FIG. 31), the horizontal separation device 14 comprises a support table 80 for receiving the insulating glazing 1, a separation head 81a, a plurality of edge support rollers 82, a plurality of edge drive rollers 83 and an edge drive belt 84. The edge support rollers 82, the edge drive rollers 83 and the edge drive belt 84 form a drive unit 91a of the separation device 14 for driving the insulating glazing 1 in the feed direction 45.

The horizontal separation device 14 also comprises a first, preferably horizontal, surface direction or x-direction, a second, preferably horizontal, surface direction or y-direction perpendicular to it and a, preferably vertical, z-direction or height direction perpendicular to the x- and y-directions.

The support table 80 comprises a, preferably horizontal, support surface 85 for receiving the insulating glazing 1. In particular, the support surface 85 serves to receive the insulating glazing surface 1b facing the support table 80. The insulating glazing 1 therefore rests on the support surface 85 with the insulating glazing surface 1b facing the support table 80. The support surface 85 is parallel to the x and y directions. In addition, the support table 80 is designed in a manner known per se in such a way that the insulating glazing 1 can be displaced on the support table 80 parallel to the support surface 85 or is displaceably mounted. Preferably, the support table 80 is designed as a ball roller table or an air cushion table for this purpose.

Furthermore, the support table 80 comprises two longitudinal table edges 86a;b extending parallel to the x-direction and two lateral table edges 86c;d perpendicular thereto and extending parallel to the y-direction.

Preferably, the support table 80 also comprises a table recess 87 extending from a first longitudinal table edge 86a into the support table 80, within which an operator 88 can stay. In addition, the support table 80 comprises a first and a second table area 80a;b when viewed in the x-direction. The first table area 80a is in particular a feed area or an infeed area.

The edge support rollers 82, the edge drive rollers 83, the separation head 81a and the edge drive belt 84 are arranged along the second longitudinal table edge 86b. They are arranged one behind the other in the x-direction seen from the first table area 80a to the second table area 80b.

The edge support rollers 82 are not driven and are freely rotatable about edge support roller rotation axes perpendicular to the support surface 85. The edge support rollers 82 serve to guide the insulating glazing 1 in the x-direction. For this purpose, the insulating glazing edge 1c, along which the separation process takes place, rests against the edge support rollers 82. The insulating glazing 1 is pressed against the edge support rollers 82, in particular by the operator 88.

The edge support rollers 82 are followed by the edge drive rollers 83 in the x-direction seen from the first table area 80a to the second table area 80b.

The edge drive rollers 83 are driven rotatably about edge drive roller rotation axes perpendicular to the support surface 85. The edge drive rollers 83 serve for driving the insulating glazing 1 in the x-direction. For this purpose, the insulating glazing edge 1c, along which the separation process takes place, rests against the edge drive rollers 83. The insulating glazing 1 is pressed against the edge drive rollers 83, in particular by the operator 88.

The separation head 81a follows the edge drive rollers 83 in the x-direction seen from the first table area 80a to the second table area 80b.

The separation head 81a serves for making horizontal separation cuts along one of the insulating glazing edges 1c.

For this purpose, the separation head 81a comprises two rotary knives 27 as well as the knife drive motor 30 and preferably the lubricating device for lubricating the rotary knives 27 with the above-mentioned, preferably liquid lubricant.

The two rotary knives 27 are respectively connected to the knife drive motor 30 so as to be drivable about their knife rotation axis 27a. The two rotary knives 27 are preferably arranged coaxially to one another with their knife rotation axes 27a. They are also preferably mounted on the same knife drive shaft 35.

The knife rotation axis 27a is respectively perpendicular to the insulating glazing surfaces 1a; 1b of the insulating glazing 1 to be disassembled. However, as described above, it can also be inclined both about a first knife axis inclination axis 27-1 and about a second knife axis inclination axis 27-2 towards the respective glass pane surface 2b against which the rotary knife 27 bears during the separation process.

As described above, the first knife axis inclination axis 27-1 is parallel to the insulating glazing edge 1c along which the separation process takes place, i.e. parallel to the x-direction. And the second knife axis inclination axis 27-2 is, as described above, perpendicular to the insulating glazing edge 1c along which the separation process takes place, and in this case parallel to the support surface 85, i.e. parallel to the y-direction.

Preferably, the rotary knives 27 are also mounted so as to float or as to be movable back and forth by a limited amount in a direction parallel to the knife rotation axis 27a. Preferably, the rotary knives 27 are mounted in a spring-loaded manner, with the spring force acting against the weight force in order to compensate for the weight force of the rotary knives 27 and, in particular, of the components connected to the rotary knives 27 and being mounted floating together with them (=rotary knife unit). The rotary knife unit is therefore mounted vertically “floating”. Due to the floating bearing, the rotary knife 27 nestles against the glass pane 2, which will be discussed in more detail below.

The edge drive belt 84 follows the separation head 81a in the x-direction seen from the first table area 80a to the second table area 80b. The edge drive belt 84 also serves to drive the insulating glazing 1 in the feed direction 45. For this purpose, the insulating glazing edge 1c, along which the separation process takes place, is in contact with the edge drive belt 84. The insulating glazing 1 is pressed against the edge drive belt 84, in particular by the operator 88.

For separating, an insulating glazing unit 1 to be disassembled is first placed on a first table area 80a (FIG. 31) and pressed by the operator 88 with one of its insulating glazing edges 1c against the edge support rollers 82 and the edge drive rollers 83.

The insulating glazing 1 is not yet in contact with the edge drive belt 84 and is not yet in engagement with the rotary knives 27. However, the upper rotary knife 27 is already positioned in height so that it can separate the upper glass pane 2 from the spacer frame 3.

Now the insulating glazing 1, driven by the edge drive rollers 83, is moved in the feed direction 45. In doing so, the insulating glazing edge 1c comes into engagement with the rotating rotary knife 27 and then with the edge drive belt 84 and is additionally driven by the latter.

The upper, rotating rotary knife 27 first penetrates into the secondary seal 5 and then between the inner glass pane surface 2b and the spacer frame 3, in doing so cuts the primary and secondary seals 4; 5 and thereby separates the upper glass pane 2 from the spacer frame 3 along the insulating glazing edge 1c.

Preferably, the rotary knife 27 rotates in a knife rotation direction 90 that is opposite or counter-acting to the feed direction 45. This means that the cutting edge ridge 38 of the rotary knife 27, when engaged, moves in the opposite direction to the feed direction 45 or to the insulating glazing 1.

Thus, counter-acting rotation direction generally means that the insulating glazing 1 and the cutting edge ridge 38 of the rotary knife 27, in the area with which it is engaged, move relative to each other in the opposite direction parallel to the insulating glazing edge 1c. In contrast, a co-rotating rotation direction means that the insulating glazing 1 and the cutting edge ridge 38 of the rotary knife 27, in the area with which it engages, move relative to one another in the same direction parallel to the insulating glazing edge 1c.

The counter-acting rotation direction prevents, among other things, a coupling or uncontrolled drive of the insulating glazing 1 by the rotary knife 27. This is advantageous, as high forces can occur during coupling and the insulating glazing 1 must therefore be held accordingly for safety.

In addition, the circumferential speed of the rotary knife 27, in particular in the case of a counter-acting rotation direction, is preferably 0.5 to 10 m/s, preferably 1 to 5 m/s.

And the relative speed between the insulating glazing 1 and the knife rotation axis 27a of the rotary knife 27 parallel to the insulating glazing edge 1c, along which the separation process takes place, is preferably 0.05 to 2 m/s, preferably 0.2 to 1.5 m/s. If only the insulating glazing 1 is moved in the feed direction 45 during the separation process, the relative speed is the feed speed of the insulating glazing 1 in the feed direction 45.

Preferably, the circumferential speed of the rotary knife 27 is greater than the relative speed between the insulating glazing 1 and the knife rotation axis 27a of the rotary knife 27. In particular, the circumferential speed of the rotary knife 27 is 2 to 15 times, preferably 3 to 12 times, the relative speed between the insulating glazing 1 and the knife rotation axis 27a of the rotary knife 27. As a result, the lubricant is conveyed particularly effectively into the gap to be lubricated.

The insulating glazing 1 is moved in the feed direction 45 until the upper rotary knife 27 is no longer engaged.

The insulating glazing 1 is then moved back into the first table area 80a and the lower rotary knife 27 is positioned at such a height that it can separate the lower glass pane 2 from the spacer frame 3. The separation process is then carried out in the same way as described above, except that the lower glass pane 2 is now separated from the spacer frame.

Analogously, little by little the upper and lower glass pane 2 are separated from the spacer frame along all four insulating glazing edges 1c.

Another advantage of the rotary knife rotating in the opposite rotation direction is that the primary and secondary seals 4; 5 are not pressed together when the rotary knife 27 penetrates, but are immediately cut trough. This is because the rotary knife 27 separates the seals 4; 5 from the inside to the outside. As a result, the compression force acting on the glass panes 2 is very low. The risk of glass breakage is therefore very low.

The lubricant is also conveyed into the lubrication gap particularly effectively.

In addition, the feed speed of the insulating glazing 1 is defined, as the insulating glazing 1 is driven in the feed direction 45. It can also be very high, so that productivity is increased.

According to a further embodiment (FIGS. 32 to 41), the horizontal separation device 14 comprises the support table 80 for receiving the insulating glazing 1, as well as a first and a second drive unit 91b;c for driving the insulating glazing 1 in the feed direction 45 and two separation heads 81b;c as well as a measuring unit 92.

Between the first table area 80a and the second table area 80b, there is also preferably a table interspace 93.

The two separation heads 81b;c are designed in the same way as described above and additionally comprise two gauging wheel sensors 89 each.

The first drive unit 91b is arranged along the first longitudinal table edge 86a and comprises a plurality of edge support rollers 82, a first edge drive belt 84, a second edge drive belt 85 and further edge support rollers 82 when viewed parallel to the x-direction seen from the first table region 80a to the second table region 80b. The first separation head 81b is arranged between the two edge drive belts 84. In addition, the table interspace 93 is present between the two edge drive belts 84.

The separation head 81b is therefore arranged within the table interspace 93.

The two gauging wheel sensors 89 of the separation head 81b are each arranged above or below the insulating glazing 1 and gauge the respective insulating glazing surface 1a;b. Such gauging wheel sensors 89 are known per se. Other sensors, e.g. non-contact sensors, are also possible.

This allows the two rotary knives 27 to be positioned precisely in height in relation to the insulating glazing surface 1a;b. The position of the rotary knife 27 parallel to the knife rotation axis 27a is thus regulated. In particular, unevenness and differences in thickness can be detected and compensated for during the separation process.

The second drive unit 91c is arranged opposite the first drive unit 91b when viewed in the y-direction. It comprises a first edge drive belt 84, a second edge drive belt 85 and edge support rollers 82 when viewed parallel to the x-direction from the first table area 80a to the second table area 80b. The second separation head 81b is arranged between the two edge drive belts 84. In addition, the table interspace 93 is provided between the two edge drive belts 84. The separation head 81c is therefore arranged within the table interspace 93.

The two gauging wheel sensors 89 of the separation head 81c are arranged above and below the insulating glazing 1 respectively, as described above, and gauge the respective insulating glazing surface 1a;b.

Furthermore, the second drive unit 91c is mounted so as to be movable back and forth in the y-direction. To drive the drive unit 91c in the y-direction, the drive unit 91c comprises corresponding drive means.

The measuring unit 92 is preferably arranged in the first table region 80a adjacent to the first edge drive belt 84. The measuring unit 92 is used to determine certain properties of the insulating glazing units 1 to be disassembled, in particular to measure the insulating glazing units 1 to be disassembled. In particular, the measuring unit 92 comprises means for measuring the thickness, width and length of the insulating glazing 1. Preferably, the measuring unit 92 also comprises means for measuring the structure of the insulating glazing 1.

In particular, it is determined whether it is a double or triple insulating glazing 1. In addition, the thickness of the individual glass panes 2 of the insulating glazing 1, the thickness of the spacer frame 3 and preferably the presence of functional coatings on the glass pane surfaces 2a;b can be determined. It may also be possible to determine which gas the insulating glazing 1 is filled with. And the type of glass (borosilicate glass, soda-lime glass) can be determined if applicable.

Such measuring units are known to the skilled man, for example the GlassBuddy® from Bohle AG.

For separating, an insulating glazing 1 to be disassembled is first placed on the first table area 80a (FIG. 32) and pressed by the operator 88 with one of its insulating glazing edges 1c against the edge support rollers 82 of the first drive unit 91b.

The structure of the insulating glazing 1 is automatically determined by the measuring unit 92.

Based on these measurement results, the two upper rotary knives 27 of the two separation heads 81b;c are roughly pre-positioned in height (z-direction) so that they can separate the upper glass pane 2 from the spacer frame 3. They are therefore moved to the height between the upper glass pane 2 and the spacer frame 3.

The insulating glazing 1 is then brought into engagement with the first edge drive belts 84 of the two drive units 91b;c by the operator 88 and moved by means of these in the feed direction 45 until the insulating glazing 1 is arranged between the rotary knives 27 of the two separation heads 81b;c. In this case, the feed direction 45 is parallel to the x-direction and points from the first table area 80a to the second table area 80b.

The gauging wheel sensors 89 are now in contact with the two insulating glazing surfaces 1a;b. The two rotary knives 27 are now positioned precisely in height on the basis of the measurements taken by the gauging wheel sensors 89.

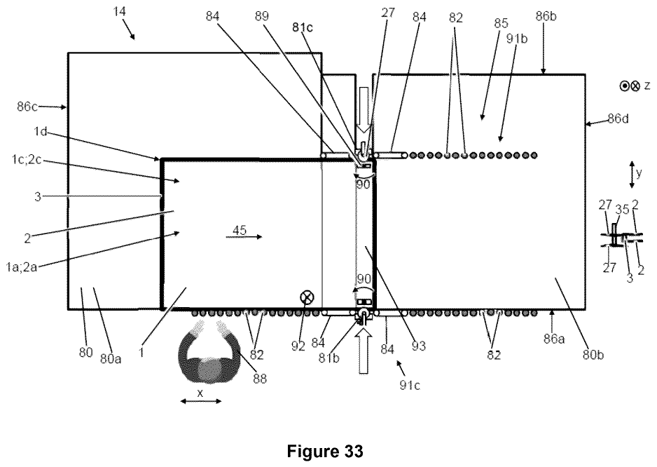

The two now rotating upper rotary knives 27 are then moved into the area between the inner glass pane surface 2b of the upper glass pane 2 and the spacer frame 3 (FIG. 33). The insulating glazing 1 is positioned in such a way that the two rotating rotary knifes 27 each move into the edge bond in the area of the respective insulating glazing edge 1c and not in an edge corner area 1d, i.e. first into the secondary seal 5 and then between the inner glass pane surface 2b and the spacer frame 3. They therefore move in between the inner glass pane surface 2b and the spacer frame 3 at a distance from the edge corner area 1d.

This ensures that no material of the spacer frame 3 and no drying agent contained therein is released. This is because there may be little primary seal 4 in the edge corner areas 1d, where the insulating glazing edges 1c merge into one another, as the bent spacer frame 3 is wider there. There is therefore a risk that the rotary knifes 27 will penetrate into the spacer frame 3 if they move in directly in the edge corner area 1d.

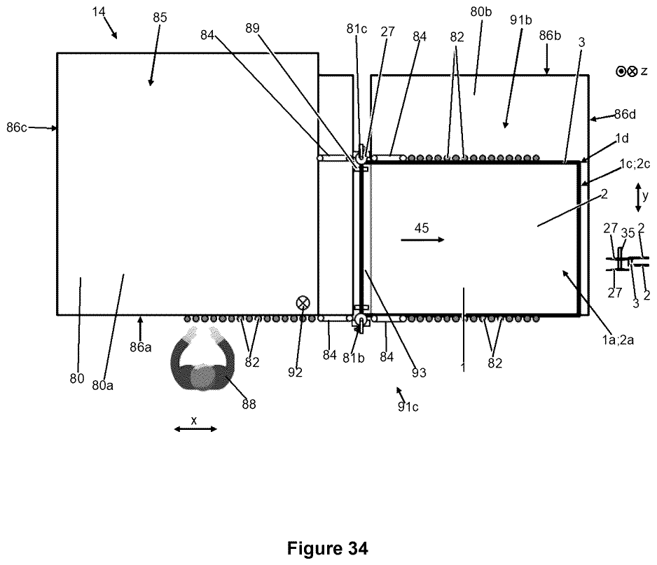

The actual separation process then takes place (FIG. 34). The rotating upper rotary knives 27 separate the upper glass pane 2 from the spacer frame 3 along the respective insulating glazing edge 1c. If necessary, the height of the upper rotary knives 27 is readjusted based on the measurement results of the gauging wheel sensors 89. This is not necessary with a floating mounting.

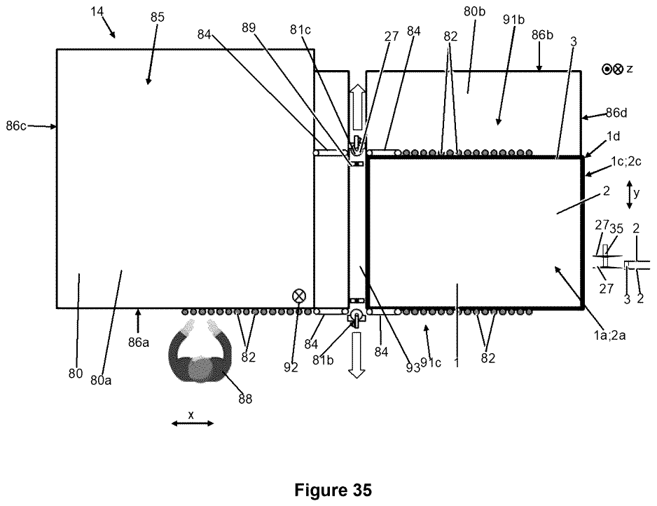

The insulating glazing 1 is moved in the feed direction 45 until the two upper rotary knifes 27 are no longer engaged (FIG. 35).

Now the rotary knives 27 are moved away from the respective insulating glazing edge 1c and the lower rotary knives 27 are roughly pre-positioned in height (z-direction) so that they can separate the lower glass pane 2 from the spacer frame 3 (FIG. 35). They are therefore moved to the height between the lower glass pane 2 and the spacer frame 3.

The insulating glazing 1 is then brought into engagement with the second edge drive belts 84 of the two drive units 91b;c by the operator 88 and moved by means of these in the feed direction 45 until the insulating glazing 1 is arranged between the rotary knives 27 of the two separation heads 81b;c. In this case, the feed direction 45 is opposite, namely parallel to the x-direction and points from the second table area 80b towards the first table area 80a.

The gauge wheel sensors 89 are now once again in contact with the two insulating glazing surfaces 1a;b. The height of the two lower rotation knives 27 is now precisely positioned on the basis of the measurements taken by the gauging wheel sensors 89.

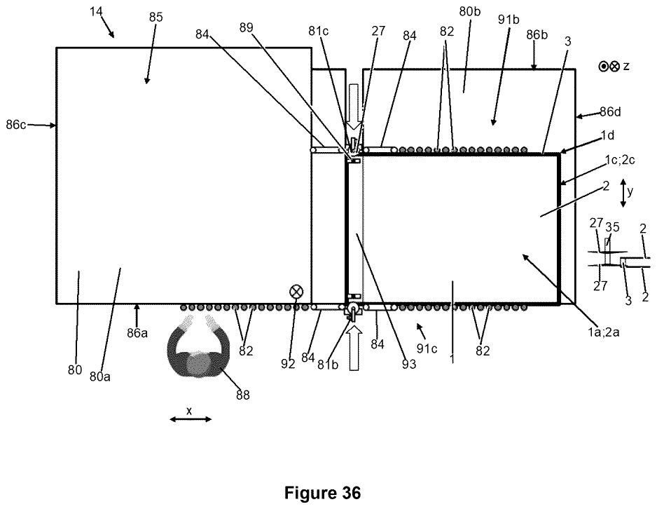

The two now rotating lower rotary knives 27 are then moved into the area between the inner glass pane surface 2b of the lower glass pane 2 and the spacer frame 3 (FIG. 36). The insulating glazing 1 is again positioned in such a way that the two rotating rotary knives 27 each move in between the inner glass pane surface 2b and the spacer frame 3 in the area of the respective insulating glazing edge 1c and not in the edge corner area 1d.

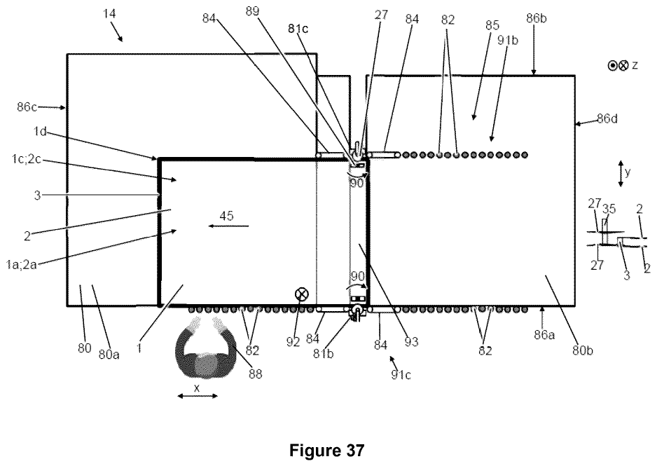

The actual separation process (FIG. 37) is then carried out in the same way as described above for separating the upper glass pane 2.

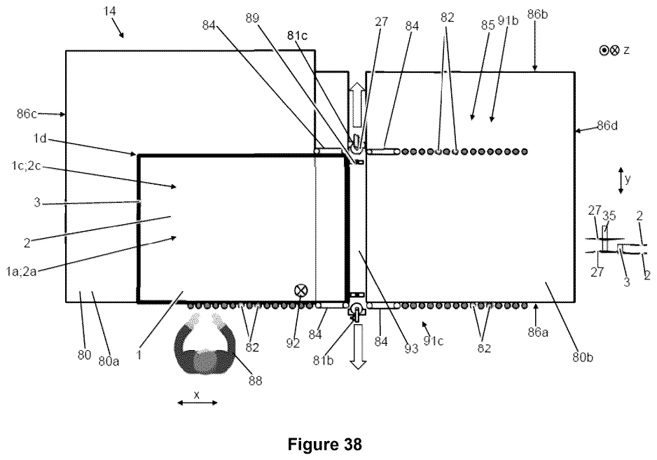

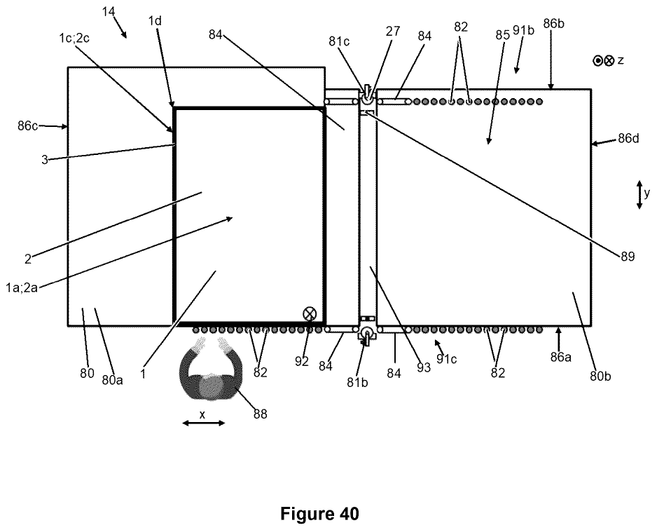

After the separation process, the rotary knifes 27 are moved away from the respective insulating glazing edge 1c and the upper rotary knifes 27 are again roughly pre-positioned in height (z-direction) so that they can separate the upper glass pane 2 from the spacer frame 3 (FIG. 38). Now the insulating glazing 1 is rotated by 90° and, as described above, the upper and lower glass pane 2 are separated from the spacer frame 3 along the other two insulating glazing edges 1c (FIG. 40).

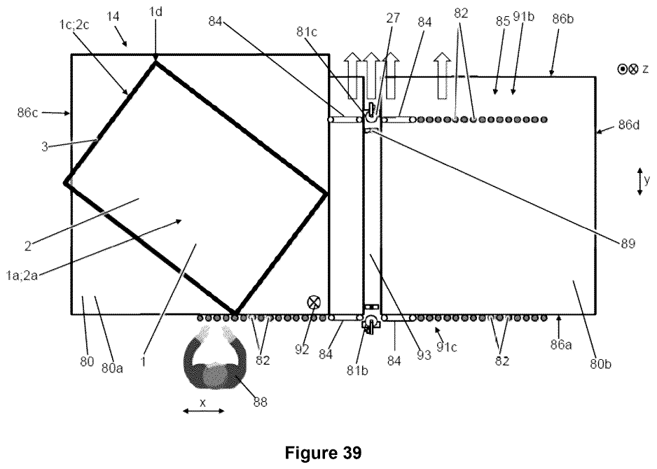

The second, movable drive unit 91c is also moved in the y-direction to the required position (FIG. 39).

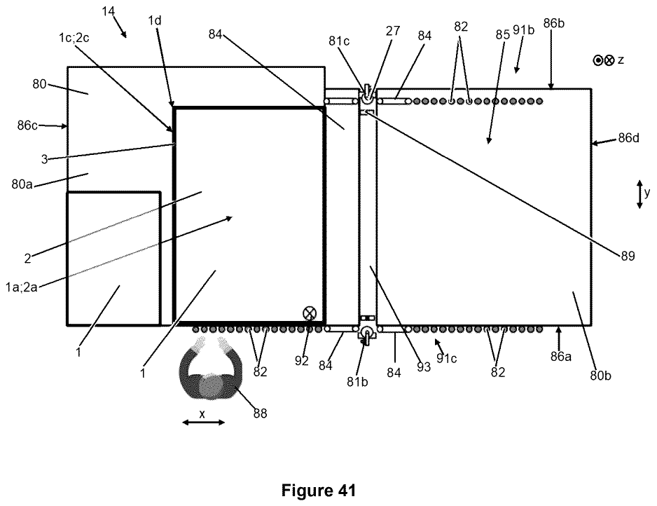

As soon as the two glass panes 2 are completely separated from the spacer frame 3, the insulating glazing 1 is removed and the next, already pre-positioned insulating glazing 1 can be cut (FIG. 41).

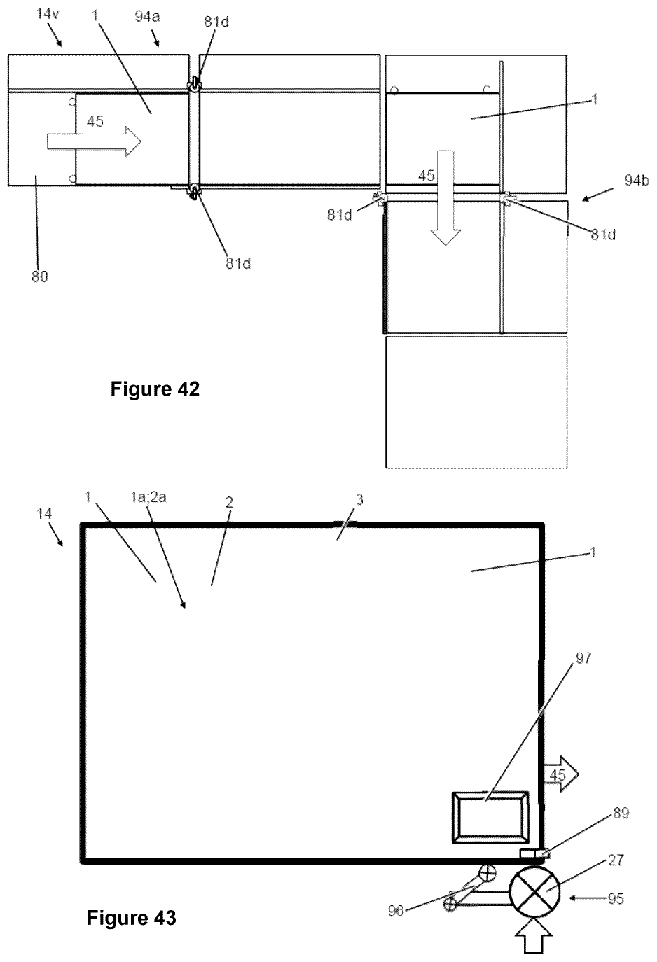

According to a further embodiment (FIG. 42), the horizontal separation device 14 comprises a first separation area 94a and a second separation area 94b, each with two separation heads 81d.

In the first separation area 94a, the separation process takes place along two opposing insulating glazing edges 1c. The insulating glazing 1 is moved in the feed direction 45. In the second separation area 94b, the feed direction 45 is perpendicular to the feed direction 45 in the first separation area 94b. The separation process thus takes place along the other two opposing insulating glazing edges 1c.

In this way, for example, the upper glass pane 2 is first completely separated from the spacer frame 3 and then the insulating glazing 1 passes through the separation device 14 once again to separate the lower glass pane 2 from the spacer frame 3.

The advantage of carrying out the separation process on the lying insulating glazing 1 is the lower load on the insulating glazing 1. Cracks in the glass panes 2 can thus be avoided or reduced. The work safety for the operator 88 is also higher.

The advantage of the counter-acting knife rotation direction 90 is that a proper separation is always guaranteed. In particular, there is no risk of the primary seal 4 being compressed and the glass panes 2 being pushed apart as a result, which causes high forces. The force required to advance the insulating glazing 1 and the force to be applied by the rotary knife 27 act in opposite directions, which avoids the risk of force coupling and stabilizes the cutting process.

However, the knife rotation direction 90 can also be concurrent. Preferably, however, the rotary knife then has the high rotational speed described above.

In addition, the lubrication during the separation process ensures that the primary seal 4 and the rotary knife 27 do not stick together and that the separated glass pane 2 does not stick to the primary seal 4 again. The rotary knife 27 also heats up less due to lower frictional forces and cooling. And separation can be carried out at higher speeds.

Alternatively or additionally, it is also advantageous if the rotary knife 27 comprises a non-stick coating at least in the area of the blade contact surface 39. The non-stick coating preferably consists of DLC (diamond-like carbon) or PTFE (polytetrafluoroethylene).

As already explained, the flexibility of the rotary knifes 27 is very advantageous. The flexibility of the rotary knifes 27 supports the threading process and compensates for irregularities during the separation process.

FIG. 50 shows the threading process and the S-shaped deformation of the flexible rotary knife. It can be seen that the blade contact surface 39 is preferably not initially coplanar with the inner glass pane surface 2b of the glass pane 2 that is to be cut off, but is spaced inwards from the glass pane surface 2b by a safety distance S in a direction perpendicular to the glass pane surface 2b. This ensures that the knife blade 33 always moves in the secondary seal 5 first and not against the glass pane 2. When penetrating the secondary seal 5, the knife blade 33 also moves towards the inner glass pane surface 2b due to the asymmetrical wedge shape of the cutting edge 37 until it rests against it and threads between the spacer frame 3 and the inner glass pane surface 2b. As a result of the deformation of the rotary knife 27, the blade contact surface 39 therefore comes to rest against the inner glass pane surface 2b. The acute cutting edge 37 causes centering and further facilitates threading.

The safety distance S is preferably 0.1 to 0.5 mm, preferably 0.2 to 0.4 mm.

FIG. 51 shows the threading process when the rotary knife 27 is mounted in a floating manner. It can be seen that, due to the floating mounting, the rotary knife 27 can move towards the inner glass pane surface 2b of the glass pane 2 that is to be cut off and the blade contact surface 39 comes to rest against the inner glass pane surface 2b. The floating mounting also makes it possible to compensate for unevenness in the insulating glazing 1 and uneven pane interspaces 7.

Preferably, the rotary knife 27 moves simultaneously both towards the insulating glazing edge 1c and relative to the insulating glazing 1 in a direction parallel to the insulating glazing edge 1 when plunging into the edge bond of the insulating glazing 1. Preferably, the relative speed parallel to the insulating glazing edge 1c is greater than the speed towards the insulating glazing edge 1c. This allows the rotary knife 27 to travel a longer distance in order to lean against the inner glass pane surface 2b when cutting the secondary seal 5 without the cutting edge ridge 38 touching the spacer frame 3.

This increases the service life of the rotary knife and prevents the spacer frame 3 from being cut open.

The described threading process and the floating bearing are of course also advantageous for vertical cutting.

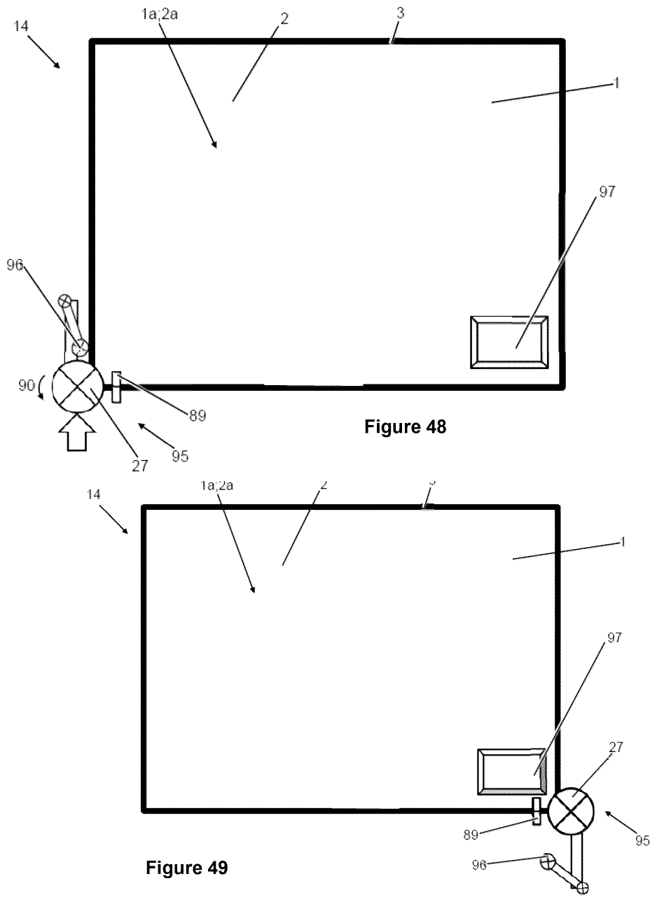

FIGS. 43 to 49 also show, in a highly simplified and schematic form, a further separation device 14 for separating when the insulating glazing 1 is upright, in particular vertical.

The separation device 14 comprises two rotary knives 27 on the separation head 95, a knife drive motor 30 and two gauging wheel sensors 89 for gauging the two insulating glazing surfaces la; b and a gauging wheel 96 for gauging the insulating glazing edge 1c along which the separation process takes place. The gauging wheel 96 also serves, among other things, to readjust or keep constant the distance between the knife rotation axis 27a and the insulating glazing edge 1c. Other sensors, e.g. non-contact sensors, are of course also possible.

The separation device 14 also comprises one or more suction grippers 97 for gripping the insulating glazing 1.

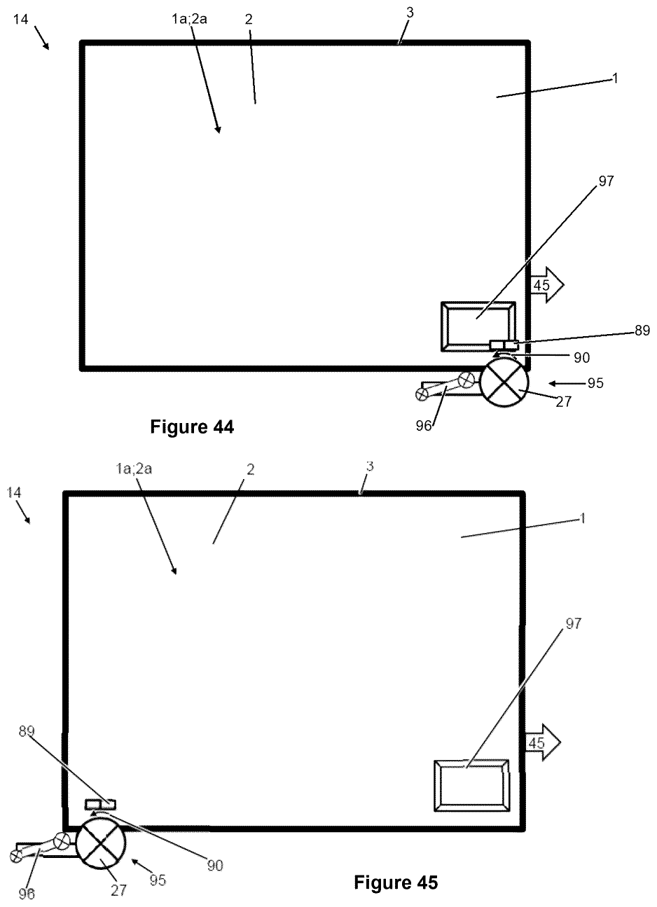

First, the front glass pane 2 is preferably separated from the spacer frame 3 along the upper insulating glazing edge 1c. In this case too, at the beginning of the separation process, the front, rotating rotary knife 27 does not move into the edge bond, i.e. into the secondary seal 5 and then into the area between the front glass pane 2 and the spacer frame 3, in the area of the edge corner area 1d, but in the area of the insulating glazing edge 1c (FIG. 44). Meanwhile, the insulating glazing 1 is moved in the feed direction 45.

The rotary knife 27 again preferably comprises a knife rotation direction 90 that is counter-acting to the feed direction 45.

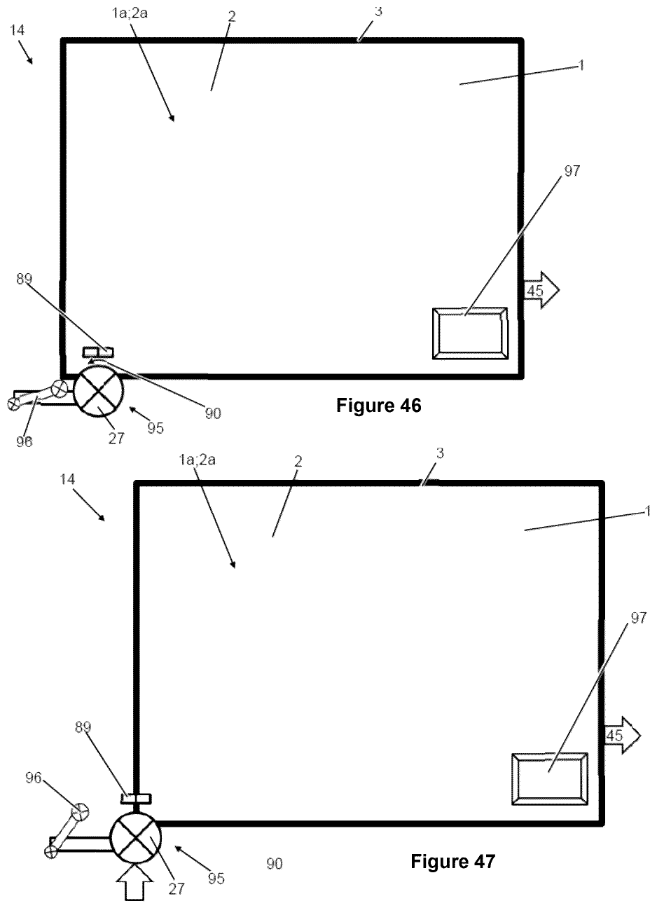

As soon as the gauging wheel 96 detects the end of the insulating glazing edge 1c, the insulating glazing 1 is braked (FIG. 46).

As soon as the rotary knife 27 reaches the end of the insulating glazing edge 1c, the separation head 95 moves around the edge corner area 1d. It is rotated by 90° for this purpose. The rotary knife 27 remains in the area between the front glass pane 2 and the spacer frame 3, so that a separation also takes place in the edge corner area 1d. In particular, a simultaneous movement of insulating glazing 1 and rotary knife 27 takes place here, as is known in edge processing, for example.

After moving around the edge corner area 1d, the separation head 95 moves vertically upwards for the separation process along the vertical insulating glazing edge 1c.

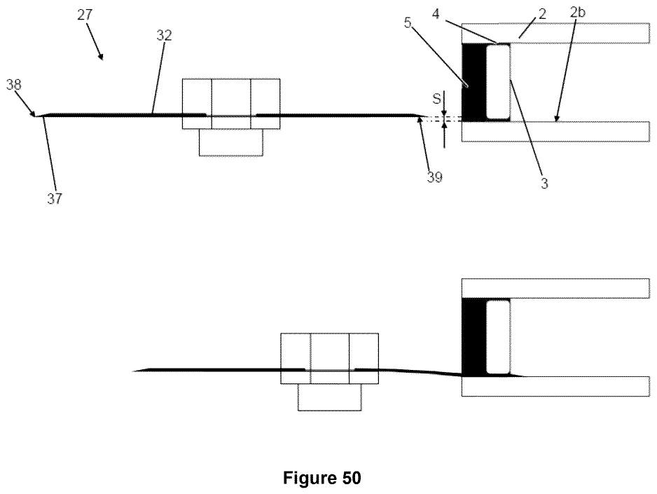

In this way, the separation head 95 moves around the insulating glazing 1 until the front glass pane 2 is separated from the spacer frame 3 along all insulating glazing edges 1c. At the end, the separation also takes place in the last edge corner area 1d (FIG. 49).

The rear glass pane 2 is then separated from the spacer frame 3 in the same way using the rear rotary knife 27.

The advantage of this method is that the rotary knife 27 only moves once into the secondary seal 5 and then into the area between the glass pane 2 to be separated and the spacer frame 3.

Of course, this procedure can also be carried out analogously for horizontal insulating glazing 1.

Of course, it is also within the scope of the invention to use drive means other than those described for driving the insulating glazing 1. Pushers and/or suction grippers are generally preferred.

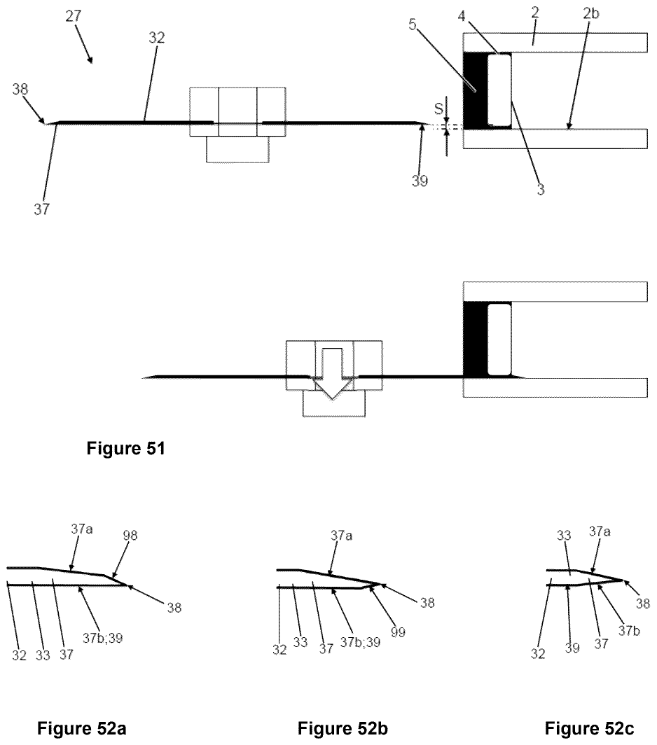

Furthermore, the cutting edge 37 of the rotary knife 27 can also be designed differently (see FIGS. 52a-c).

According to an advantageous embodiment (FIG. 52a), a pre-facet 98 is present between the first and second cutting edge surfaces 37a; 37b. The pre-facet 98 and the second cutting edge surface 37b then merge into one another in the circumferential cutting edge ridge 38. The pre-facet 98 can contribute to increasing the service life of the rotary knife 27. Even if they no longer merge directly but via the pre-facet 98, the two cutting edge surfaces 37a; 37b still form an acute cutting edge angle with each other and the second cutting edge surface 37b is perpendicular to the knife rotation axis 27a and forms at least part of the blade contact surface 39.

According to a further advantageous embodiment (FIG. 52b), a chamfer 99 is present between the first and second cutting edge surfaces 37a; 37b. The chamfer 99 and the first cutting edge surface 37a then merge into one another in the circumferential cutting edge ridge 38. Even if they no longer merge directly but via the chamfer 99, the two cutting edge surfaces 37a; 37b still form an acute cutting edge angle with each other and the second cutting edge surface 37b is perpendicular to the knife rotation axis 27a and forms at least part of the blade contact surface 39.

In the embodiments described, the cutting edge 37 of the rotary knife 27 is thus designed in such a way that when the cutting edge 37 penetrates the secondary seal 5 in the direction perpendicular to the insulating glazing edge 1c, a force directed towards the glass pane surface 2b of the glass pane that is to be cut off acts on the cutting edge 37.

According to a further embodiment (FIG. 52c), the first and second cutting edge surfaces 37a;b merge into one another in the circumferential cutting edge ridge 38. The two cutting edge surfaces 37a; 37b continue to form an acute cutting edge angle with each other. However, the second cutting edge surface 37b is no longer parallel to the knife rotation axis 27a, but also forms an obtuse angle with it. The two cutting edge surfaces 37a; 37b are symmetrical to a center plane perpendicular to the knife rotation axis 27a. In this embodiment, threading between the spacer frame 3 and the inner surface of the glass pane 2b does not occur due to the force described above, but due to the acute shape of the knife blade 33. The advantage of this embodiment is that the same rotary knife can be used for both glass panes 2 of the insulating glazing 1.

As already explained, the separation method according to the invention and the separation device according to the invention are used for separating insulating glazing units which comprise a spacer tube and a primary and a secondary seal. It is also advantageously possible to separate a glass pane of an insulating glazing unit from a TPS spacer using the separation device according to the invention and/or the separation method according to the invention. The TPS spacer is cut through by means of the rotating blade.

The foregoing description of various forms of the invention has been presented for purposes of illustration and description. It is not intended to be exhaustive or to limit the invention to the precise forms disclosed. Numerous modifications or variations are possible in light of the above teachings. The forms discussed were chosen and described to provide the best illustration of the principles of the invention and its practical application to thereby enable one of ordinary skill in the art to utilize the invention in various forms and with various modifications as are suited to the particular use contemplated. All such modifications and variations are within the scope of the invention as determined by the appended claims when interpreted in accordance with the breadth to which they are fairly, legally, and equitably entitled.

1. A separation method for separating a glass pane of an insulating glazing from a, preferably rigid, spacer frame connected to the glass pane by a primary seal,
wherein a secondary seal, which is also connected to the glass pane, is arranged outside around the spacer frame,
whereby the secondary seal and the primary seal are cut through with a knife,
wherein a rotary knife, preferably a circular knife, rotating about a knife rotation axis is used to separate the secondary seal and the primary seal,
wherein the rotary knife is lubricated during the separation process with a, preferably liquid, lubricant, preferably with a lubricating emulsion, in particular with a water-based or oil-based lubricating emulsion, or with a lubricating oil or with water.

2. The separation method according to claim 1, wherein the rotary knife is driven around the knife rotation axis during the separation process.

3. The separation method according to claim 1, wherein the rotary knife comprises a blade contact surface, preferably perpendicular to the knife rotation axis, which during the separation process bears against an inner glass pane surface of the glass pane bonded to the spacer frame via the primary seal.

4. The separation method according to claim 3, wherein the rotary knife comprises a knife basic body and a knife blade which adjoins the knife basic body radially outwards and comprises the blade contact surface.

5. The separation method according to claim 4, wherein the knife blade comprises a cutting edge with a circumferential cutting edge ridge, wherein the cutting edge is preferably toothless.

6. The separation method according to claim 5, wherein
a) the cutting edge comprises a first and a second, in particular planar, respectively circumferential cutting edge surface, wherein the two cutting edge surfaces merge into one another in the circumferential cutting edge ridge and the two cutting edge surfaces enclose an acute cutting edge angle with one another and the second cutting edge surface is perpendicular to the knife rotation axis and in particular forms at least a part of the blade contact surface, or
b) the cutting edge comprises the first and second, in particular planar, respectively circumferential cutting edge surfaces, wherein the two cutting edge surfaces merge into one another via a pre-facet and the pre-facet and the second cutting edge surface merge into one another in the circumferential cutting edge ridge and the two cutting edge surfaces enclose an acute cutting edge angle with one another and the second cutting edge surface is perpendicular to the knife rotation axis and in particular forms at least a part of the blade contact surface, or
c) the cutting edge comprises the first and second, in particular planar, respectively circumferential cutting edge surfaces, wherein the two cutting edge surfaces merge into one another via a chamfer and the chamfer and the first cutting edge surface merge into one another in the circumferential cutting edge ridge and the two cutting edge surfaces enclose an acute cutting edge angle with one another and the second cutting edge surface is perpendicular to the knife rotation axis and in particular forms at least a part of the blade contact surface, or
d) the cutting edge comprises the first and the second, in particular planar, respectively circumferential cutting edge surface, wherein the two cutting edge surfaces merge into one another in the circumferential cutting edge ridge and the two cutting edge surfaces enclose an acute cutting edge angle with one another and the two cutting edge surfaces are formed symmetrically with respect to a central plane perpendicular to the knife rotation axis.

7. The separation method according to claim 4, wherein the knife blade comprises a thickness of 0.2 to 1 mm, preferably 0.3 to 0.6 mm, and/or the knife basic body comprises a thickness of 0.2 to 0.8 mm, preferably 0.3 to 0.5 mm.

8. (canceled)

9. The separation method according to claim 1, wherein the rotary knife comprises a diameter of 60 to 100 mm, preferably 70 to 90 mm.

10. The separation method according to claim 1, wherein the rotary knife comprises a static rigidity of 3 to 25 N/mm, preferably 5 to 20 N/mm.

11. The separation method according to claim 1, wherein the rotary knife is made of metal, preferably steel.

12. The separation method according to claim 1, wherein the separation process takes place along the insulating glazing edges of the insulating glazing.

13. The separation method according to claim 3, wherein the separation process takes place along the insulating glazing edges of the insulating glazing and the rotary knife, at the beginning of the separation process, as seen in a direction perpendicular to the insulating glazing edge along which the separation process takes place, first penetrates into the secondary seal and then into the region between the glass pane to be separated and the spacer frame, wherein the blade contact surface, when penetrating into the secondary seal, is preferably positioned in such a way that it is offset inwards by a safety distance from the glass pane surface when viewed in a direction perpendicular to the glass pane surface, wherein the safety distance is preferably 0.1 to 0.5 mm, preferably 0.2 to 0.4 mm.

14. The separation method according to claim 13, wherein the blade contact surface moves towards the inner glass pane surface when penetrating into the secondary seal until it rests against it.

15. The separation method according to claim 13, wherein the knife blade comprises a cutting edge with a circumferential cutting edge ridge and the cutting edge of the rotary knife is designed in such a way that when the cutting edge penetrates into the secondary seal in the direction perpendicular to the insulating glazing edge, a force directed towards the glass pane surface acts on the cutting edge.

16. The separation method according to claim 12, wherein at the beginning of the separation process, the rotary knife does not move first into the secondary seal and then into the region between the glass pane to be separated and the spacer frame in the area of an edge corner region in which two insulating glazing edges merge into one another, but it moves first into the secondary seal and then into the region between the glass pane to be separated and the spacer frame in the area of an insulating glazing edge.

17. The separation method according to claim 16, wherein the rotary knife runs along at least two, preferably all, insulating glazing edges of the insulating glazing one after the other and remains in the region between the front glass pane and the spacer frame during the transition from one to the next insulating glazing edge, so that separation also takes place in the edge corner region.

18. The separation method according to claim 13, wherein the rotary knife is also moved in a direction parallel to the insulating glazing edge relative to the insulating glazing when penetrating into the secondary seal and after that into the area between the glass pane to be separated and the spacer frame.

19. The separation method according to claim 12, wherein a direction of rotation of the rotary knife is concurrent or counter-acting to the relative movement between the rotary knife and the insulating glazing in a direction parallel to the insulating glazing edge along which the separation process takes place.

20. The separation method according to claim 1, wherein the circumferential speed of the rotary knife in particular in the case of a counter-acting direction of rotation, is 0.5 to 10 m/s, preferably 1 to 5 m/s.

21. The separation method according to claim 12, wherein the circumferential speed of the rotary knife is 2 to 15 times, preferably 3 to 12 times, a relative speed between the insulating glazing and the knife rotation axis of the rotary knife parallel to the insulating glazing edge along which the separation process takes place.

22. The separation method according to claim 1, wherein the rotary knife is floatingly mounted in a direction parallel to the knife rotation axis.

23. The separation method according to claim 1, wherein the insulating glazing is upright during the separation process and is guided on one of its insulating glazing edges or is arranged lyingly.

24. A method for disassembling insulating glazing with at least two glass panes arranged parallel to and spaced apart from one another and with a spacer frame arranged between the glass panes in a pane boundary area, wherein a pane interspace is delimited by the glass panes and the spacer frame,
wherein the spacer frame is bonded to the two glass panes via a primary seal respectively and wherein the insulating glazing comprises a secondary seal arranged outside around the spacer frame,
wherein for disassembling the spacer frame and the secondary seal are separated from the glass panes,
wherein the separation of the secondary seal and also of the spacer frame from the glass panes is carried out according to the separation method according to claim 1.

25. The method according to claim 24, wherein the separation process takes place along the insulating glazing edges of the insulating glazing and during separating along an insulating glazing edge at least partially two glass panes of the insulating glazing are simultaneously separated from the spacer frame, wherein preferably the knife rotation axes of the two rotary knifes used for separating are coaxial to one another or are offset to one another in a direction parallel to the insulating glazing edge.

26. A reprocessing method for the, in particular automated, reprocessing of insulating glazing with at least two glass panes arranged parallel to and spaced apart from one another and with a spacer frame arranged between the glass panes in a pane boundary area, wherein a pane interspace is delimited by the glass panes and the spacer frame, wherein the spacer frame is bonded to the two glass panes via a primary seal respectively and wherein the insulating glazing comprises a secondary seal arranged outside around the spacer frame, with the following method steps:
a) Preferably measuring the insulating glazing to be disassembled,
b) Preferably degassing the pane interspace,
c) Disassembling the insulating glazing according to claim 24, and
d) Preferably removing of sealing residues of the primary and secondary seal adhering to the glass panes.

27. A separation device, preferably for carrying out the separation method according to claim 1 for separating at least one glass pane of an insulating glazing from a, preferably rigid, spacer frame connected to the glass pane by a primary seal, wherein a secondary seal, which is also connected to the glass pane, is arranged outside around the spacer frame,
wherein the separation device comprises at least one knife for separating,
wherein the knife is a rotary knife, preferably a circular knife, rotatable about a knife rotation axis,
wherein the separation device preferably comprises a knife drive motor (30), to which the rotary knife is connected so that it can be driven to rotate about the knife rotation axis, the separation device comprises at least one separation head, which comprises at least one rotary knife, preferably at least two rotary knifes, which is mounted rotatably about the knife rotation axis,
wherein the at least one separation head comprises a lubricating device for lubricating the at least one rotary knife with a, preferably liquid, lubricant, preferably a lubricating emulsion, in particular a water-based or oil-based lubricating emulsion, or a lubricating oil or water.

28. The separation device according to claim 27, wherein
a) the separation device comprises an abutment plane for abutment of the insulating glazing surface during the separation process, the abutment plane being vertical or inclined to the vertical about a horizontal axis, an abutment plane inclination angle preferably being 3° to 10°, preferably 4° to 8°, or
b) the separation device comprises a support table for supporting the insulating glazing in a lying manner during the separation process.

29. (canceled)

30. The separation device according to claim 27, wherein the separation head comprises the knife drive motor (30), to which the rotary knife is connected so as to be rotatably drivable about the knife rotation axis.

31. The separation device according to claim 30, wherein the rotary knife is mounted so as to be movable back and forth towards and away from the insulating glazing, preferably in a direction parallel to the knife rotation axis, wherein preferably the rotary knife is connected to drive means so as to be drivable back and forth towards and away from the insulating glazing, preferably in the direction parallel to the knife rotation axis.

32. (canceled)

33. (canceled)

34. The separation device according to claim 27, wherein the rotary knife comprises a blade contact surface, preferably perpendicular to the knife rotation axis, for contact with the inner glass pane surface of the glass pane to be separated, which is bonded to the spacer frame.

35. The separation device according to claim 34, wherein the rotary knife comprises a knife basic body and a knife blade which adjoins the knife basic body radially outwards and comprises the blade contact surface.

36. The separation device according to claim 35, wherein the knife blade comprises a thickness of 0.2 to 1 mm, preferably 0.3 to 0.6 mm, and/or the knife basic body comprises a thickness of 0.2 to 0.8 mm, preferably 0.3 to 0.5 mm.

37. The separation device according to claim 27, wherein the rotary knife comprises a diameter of 60 to 100 mm, preferably 70 to 90 mm.

38. The separation device according to claim 27, wherein the rotary knife comprises a static rigidity of 3 to 25 N/mm, preferably 5 to 20 N/mm.

39. The separation device according to claim 35, wherein the knife blade comprises a cutting edge with a circumferential cutting edge ridge, wherein the cutting edge ridge is preferably toothless.

40. The separation device according to claim 39, wherein
a) the cutting edge comprises a first and a second, in particular planar, respectively circumferential cutting edge surface, wherein the two cutting edge surfaces merge into one another in the circumferential cutting edge ridge and the two cutting edge surfaces enclose an acute cutting edge angle with one another and the second cutting edge surface is perpendicular to the knife rotation axis and in particular forms at least a part of the blade contact surface, or
b) the cutting edge comprises the first and second, in particular planar, respectively circumferential cutting edge surfaces, wherein the two cutting edge surfaces merge into one another via a pre-facet and the pre-facet and the second cutting edge surface merge into one another in the circumferential cutting edge ridge and the two cutting edge surfaces enclose an acute cutting edge angle with one another and the second cutting edge surface is perpendicular to the knife rotation axis and in particular forms at least a part of the blade contact surface, or
c) the cutting edge comprises the first and second, in particular planar, respectively circumferential cutting edge surfaces, wherein the two cutting edge surfaces merge into one another via a chamfer and the chamfer and the first cutting edge surface merge into one another in the circumferential cutting edge ridge and the two cutting edge surfaces enclose an acute cutting edge angle with one another and the second cutting edge surface is perpendicular to the knife rotation axis and in particular forms at least a part of the blade contact surface, or
d) the cutting edge comprises the first and the second, in particular planar, circumferential cutting edge surface, wherein the two cutting edge surfaces merge into one another in the circumferential cutting edge ridge and the two cutting edge surfaces enclose an acute cutting edge angle with one another and the two cutting edge surfaces are formed symmetrically with respect to a central plane perpendicular to the knife rotation axis.

41. The separation device according to claim 34, wherein the knife rotation axis is perpendicular to the glass pane surface against which the rotary knife is to rest on during the separation process.

42. The separation device according to claim 34, wherein the knife rotation axis is inclined by a first angle of inclination about a first knife axis inclination axis towards the glass pane surface against which the rotary knife is to rest on during the separation process, wherein the first knife axis inclination axis is parallel to an insulating glazing edge along which the separation process is to take place, and wherein the first angle of inclination is preferably 0.05 to 5°, preferably 0.05 to 1.2°.

43. The separation device according to claim 34, wherein the knife rotation axis of is inclined by a second angle of inclination about a second knife axis inclination axis towards the glass pane surface against which the rotary knife is to rest on during the separation process, wherein the second knife axis inclination axis is parallel to the abutment plane and perpendicular to an insulating glazing edge along which the separation process is to take place, and wherein the second angle of inclination is preferably 0.05 to 3°, preferably 0.2 to 1.5°.

44. The separation device according to claim 27, wherein the rotary knife is floatingly mounted in a direction parallel to the knife rotation axis.

45. The separation device according to claim 27, wherein the rotary knife is made of metal, preferably of steel.

46. The separation device according to claim 35, wherein the knife blade can be bent elastically reformable, wherein the knife blade can preferably be bent elastically reformable by a bending angle of at least 5°, preferably at least 15°, particularly preferably at least 20°, very particularly preferably at least 30°.

47. (canceled)

48. (canceled)

49. (canceled)

50. (canceled)

51. The separation device according to claim 27, wherein the separation device comprises measuring means, preferably a camera, for measuring the glass pane thicknesses and/or the insulating glazing thickness of the insulating glazing to be separated.

52. The separation device according to claim 27, wherein the separation device is a stationary separation device.

53. A reprocessing device for the, in particular automated, reprocessing of insulating glazing with at least two glass panes arranged parallel to and spaced apart from one another and with a spacer frame arranged between the glass panes in a pane boundary area, wherein a pane interspace is delimited by the glass panes and the spacer frame, wherein the spacer frame is bonded to the two glass panes via a primary seal and wherein the insulating glazing has a secondary seal arranged outside around the spacer frame;
a) Preferably an inspection device for measuring the insulating glazing to be disassembled,
b) Preferably a degassing device for degassing the pane interspace,
c) A separation device according to claim 27 for disassembling the insulating glazing,
d) Preferably a sealing residue removal device for removing sealing residues of the primary and secondary seal adhering to the glass panes.

54. The reprocessing device according to claim 53, wherein the inspection device comprises means for measuring the insulating glazing to be disassembled, preferably means for measuring the thickness, width and length of the insulating glazing and/or means for measuring the structure of the insulating glazing.

55.-58. (canceled)
